(19) United States
(12) Patent Application Publication
(10) Pub. No.: US 2025/0173825 A1
(43) Pub. Date: May 29, 2025

(54) METHOD AND ELECTRONIC DEVICE FOR PERFORMING IMAGE PROCESSING

(71) Applicant: SAMSUNG ELECTRONICS CO., LTD., Suwon-si (KR)

(72) Inventors: Jiahui YUAN, Beijing (CN); Weihua ZHANG, Beijing (CN); Li ZUO, Beijing (CN)

(73) Assignee: SAMSUNG ELECTRONICS CO., LTD., Suwon-si (KR)

(21) Appl. No.: 18/661,234

(22) Filed: May 10, 2024

Related U.S. Application Data
(63) Continuation of application No. PCT/KR2024/005006, filed on Apr. 15, 2024.

(30) Foreign Application Priority Data
Nov. 24, 2023 (CN) 202311585734.6

(51) Int. Cl. G06T 3/4053; G06T 3/4046; G06T 5/60

(52) U.S. Cl. CPC G06T 3/4053; G06T 3/4046; G06T 5/60; G06T 2207/20081; G06T 2207/20084

(57) ABSTRACT

A method includes performing, using a first artificial intelligence (AI) network, image processing based on input information to obtain a first image and image guidance information, the image guidance information comprising at least one of spatial correlation guidance information and semantic correlation guidance information; and performing, using a second AI network, resolution processing on the first image based on the image guidance information to obtain a second image.

### CROSS REFERENCE TO RELATED APPLICATIONS

This application is a continuation of International Application No. PCT/KR2024/005006, filed on Apr. 15, 2024, which claims priority to Chinese Patent Application No. 202311585734.6, filed on Nov. 24, 2023, the disclosures of which are incorporated by reference herein their entireties.

### BACKGROUND

### 1. Field

The disclosure relates to the technical field of image processing, and more particularly, to a method executed by an electronic device, an electronic device, a storage medium and a program product.

### 2. Description of Related Art

With the continuous development and progress of science and technology, it is possible to use electronic devices to generate images beyond traditional imagination, and the generated images may be highly consistent with the user's intention. Accordingly, there is an increasing demand for generating high-quality AI images.

The related image generation technologies can generate images with low resolution, e.g., 512×512 pixels. However, users usually want images with higher resolution (e.g., 4000×3000 pixels), thereby increasing the requirements for image processing models.

At present, the models in the schemes that can obtain high-resolution images are generally too large and time-consuming, and also have difficulty in meeting the users' usage requirements.

### SUMMARY

An aspect of the embodiments of the present application is to solve the technical problem that the models in the schemes that can obtain high-resolution images are generally too large and time-consuming.

According to an embodiment of the disclosure, a method executed by an electronic device, may include obtaining, using a first artificial intelligence (AI) network, performing image processing based on input information, a first image and image guidance information. The image guidance information may include at least one of spatial correlation guidance information and semantic correlation guidance information. The method may include obtaining, using a second AI network, performing resolution processing on the first image based on the image guidance information, a second image.

According to an embodiment of the disclosure, an electronic device may include a memory storing instructions and at least one processor configured to execute the instructions to obtain, using a first artificial intelligence (AI) network, performing image processing based on input information, a first image and image guidance information. The image guidance information may include at least one of spatial correlation guidance information and semantic correlation guidance information. The electronic device may include a memory storing instructions and at least one processor configured to execute the instructions to obtain, using a second AI network, performing resolution processing on the first image based on the image guidance information, a second image.

According to an embodiment of the present disclosure, a computer-readable storage medium which is configured to store instruction is provided. The instructions, when executed by at least one processor of a device, may cause the at least one processor to perform the method corresponding.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of a method executed by an electronic device according to an embodiment;

FIG. 2 is a schematic diagram of a method of training a first AI network and/or a second AI network according to an embodiment;

FIG. 3 is a schematic diagram of a calculation method of an attention module according to an embodiment;

FIG. 4 is a schematic diagram of a token according to an embodiment;

FIG. 5 is a schematic diagram of an attention module according to an embodiment;

FIG. 6 is a schematic diagram of a process of accumulating cross-attention weight maps in all stages of all operations according to an embodiment;

FIG. 7 is a schematic diagram of extracting similar features in adjacent stages according to an embodiment;

FIG. 8 is a schematic diagram of a self-attention weight sharing process according to an embodiment;

FIG. 9 is a schematic diagram of a cross-attention weight sharing process according to an embodiment;

FIG. 10 is a schematic diagram of a processing process of a correction module according to an embodiment;

FIG. 11 is a schematic diagram of a cascaded diffusion model processing scheme according to an embodiment;

FIG. 12 is a schematic diagram of another cascaded diffusion model processing scheme according to an embodiment;

FIG. 13 is a schematic diagram of a process of realizing high-resolution image generation by a cascaded diffusion model according to an embodiment;

FIG. 14 is a schematic diagram of an application scenario of the scheme according to an embodiment;

FIG. 15 is a schematic diagram of another application scenario of the scheme according to an embodiment;

FIG. 16 is a flowchart of another method executed by an electronic device according to an embodiment; and

FIG. 17 is a schematic structure diagram of an electronic device according to an embodiment.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When a component is said to be “connected” or “coupled” to the other component, the component may be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which may be used in various embodiments of the present disclosure and does not limit one or more additional functions, operations, or components. The terms such as “include” and/or “have” may be construed to denote a certain characteristic, number, operation, operation, constituent element, component or a combination thereof, but may not be construed to exclude the existence of or a possibility of addition of one or more other characteristics, numbers, operations, operations, constituent elements, components or combinations thereof.

The term “or” used in various embodiments of the present disclosure includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” may be realized as parameter A includes A1 or A2 or A3, and it can also be realized as parameter A includes at least two of the three parameters A1, A2 and A3.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

According to an embodiment, at least some of the functions in the apparatus or electronic device provided in the embodiments of the present disclosure may be implemented by an AI model. For example, at least one of a plurality of modules of the apparatus or electronic device may be implemented through the AI model. The functions associated with the AI may be performed through a non-volatile memory, a volatile memory, and a processor.

The processor may include one or more processors. The one or more processors may be general-purpose processors such as a central processing unit (CPU), an application processor (AP), etc., or a pure graphics processing unit, such as a graphics processing unit (GPU), a visual processing unit (VPU), an AI specialized processor, such as a neural processing unit (NPU), or any other suitable processor known to one of ordinary skill in the art.

The one or more processors control the processing of input data according to predefined operating rules or artificial intelligence (AI) models stored in the non-volatile memory and the volatile memory. The predefined operating rules or AI models are provided by training or learning.

In an example, providing, by learning, refers to obtaining the predefined operating rules or AI models having a desired characteristic by applying a learning algorithm to a plurality of learning data. The learning may be performed in the apparatus or electronic device itself in which the AI according to the embodiments is performed, and/or may be implemented by a separate server/system.

According to an embodiment, the AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

In an example, the learning algorithm may be a method of training a predetermined target apparatus (e. g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided in the present disclosure may relate to one or more of technical fields such as speech, language, image, video, and data intelligence.

In an example, in the image or video field, in accordance with the present disclosure, in the method executed by an electronic device, a method for image generation, image super-resolution processing and/or image correction can obtain the repaired output data in the target repaired area in the image by using image data as input data of an AI model. The AI model may be obtained by training. In an example, “obtained by training” means that predefined operating rules or AI models configured to perform desired features (or purposes) are obtained by training a basic AI model with multiple pieces of training data by training algorithms. The method of the present disclosure may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

Next, the technical solution of the embodiments of the disclosure and the technical effects produced by the technical solution of the embodiments of the present disclosure will be described by referring to some optional embodiments. It should be noticed that the following embodiments may be referred to, learned from or combined with each other, and the same terms, similar characteristics and similar implementation operations in different embodiments are not repeated.

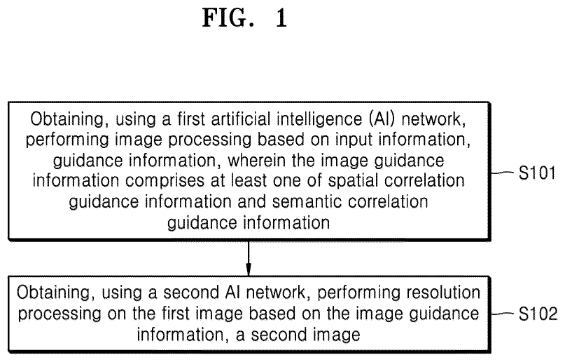

An embodiment of the disclosure provide a method executed by an electronic device. As shown in FIG. 1, the method includes the following operations.

In operation S101, edition (e.g. image processing) is performed based on input information by using a first AI network to obtain a first image and guidance information, the guidance information including at least one of spatial correlation guidance information and semantic correlation guidance information. In an example, edition may refer to generating a version of an image.

In an embodiment, the input information is basic information used for realizing image edition. In an example, the input information may be text, image or text plus image, etc., or may be voice, voice plus image, text plus voice plus image, etc., but it is not limited thereto. For example, the main task of this operation is to receive information such as text or text plus an image input by a user as input, and realize image edition based on the input information. In an example, the edition (e.g. image processing) includes, but not limited to, at least one of the following: inpainting, outpainting, text-based image generation, image fusion, image style transformation, etc. In an example, inpainting may be a process where damaged, deteriorated, or missing parts of an image are filled in to present a complete image. In an example, outpainting may be a process by which the AI generates parts of an image that are outside the image's original frame. Outpainting may be used to fix up images in which the subject is off center, or when some detail is cut off.

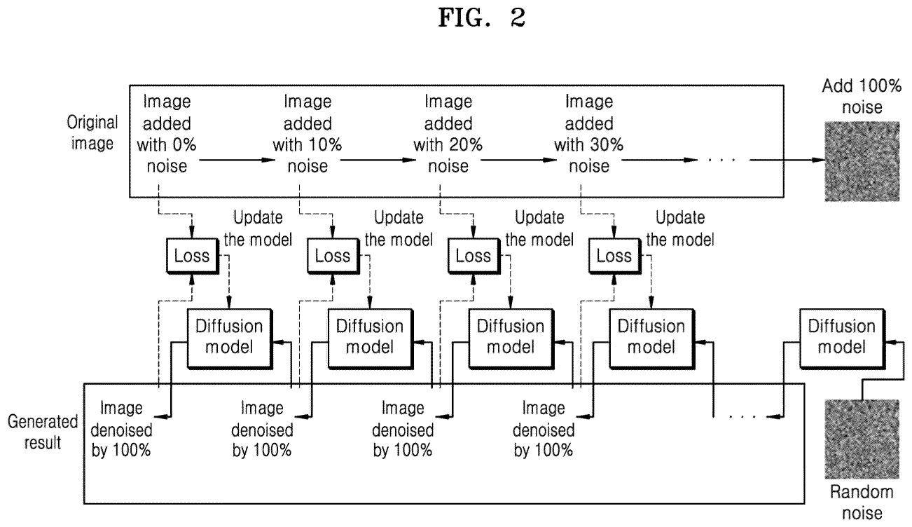

In an example, the first AI network may apply a generative model (e.g., a generative adversarial network (GAN)) or, the first AI network may apply a diffusion network model. For a given random noise image, the diffusion process using the diffusion model may remove noise step by step, and the current denoising process may be performed based on the previous denoising result. If the input includes an image, the random noise image may be obtained by adding random noise in an image. If the input does not include any image, the random noise image is randomly generated according to a predetermined algorithm. In practical applications, the degree of each denoising process may be achieved by setting different training methods according to the type of images a user needs generated. For example, as shown in FIG. 2, the first AI network may be trained in the following way: acquiring an original image used for training, and continuously adding noise to the original image until the original image is completely transformed into random noise data. The image obtained after adding noise each time is reserved for use in the training stage to update the first AI network. For each training, the first AI network may only need to predict the noise to be removed from the current input image. For example, the image that is denoised by 70% is input into the first AI network. The first AI network may only need to predict the denoised image of the current image, then compares it with the image added with 20% noise to calculate a loss, and updates model parameters. The updated first AI network may be continuously used for prediction, and the similar prediction process and model training process may be analogized and will not be repeated here. In one or more examples, the type of the first AI network is not limited thereto, and the first AI network may also be other neural network models. The type and training mode of the first AI network may be set by those skilled in the art according to the type of images a user needs generated, and the embodiments of the present disclosure are not limited to these examples.

Based on the image edition task of the first AI network, for example, by taking generating an image using text as an example, hyper-real pictures may be generated according to the text content input by the user, and these pictures are highly consistent with the meaning of the text. For example, this process is mainly the generation of an image based on the text and the understanding of the language model. With the continuous development of the big language model and the significant improvement of its text understanding capability, the quality of the output first image may be effectively ensured.

In an embodiment, the guidance information in the first AI network may be obtained when the first AI network is used to obtain the first image, wherein the guidance information includes at least one piece of spatial correlation guidance information and semantic correlation guidance information.

In an example, the spatial correlation guidance information may include a spatial correlation weight between different spatial positions. For example, the spatial correlation guidance information may specifically include a self-attention weight of the image, but it is not limited thereto.

In an example, the semantic correlation guidance information includes at least one of the semantic correlation weight between spatial positions and text content constraints and the semantic correlation weight between different spatial positions. For example, the semantic correlation guidance information may include a cross-attention weight representing the correlation between text content constraints and pixels of the image, but it is not limited thereto. The text content constraints may come from the input information.

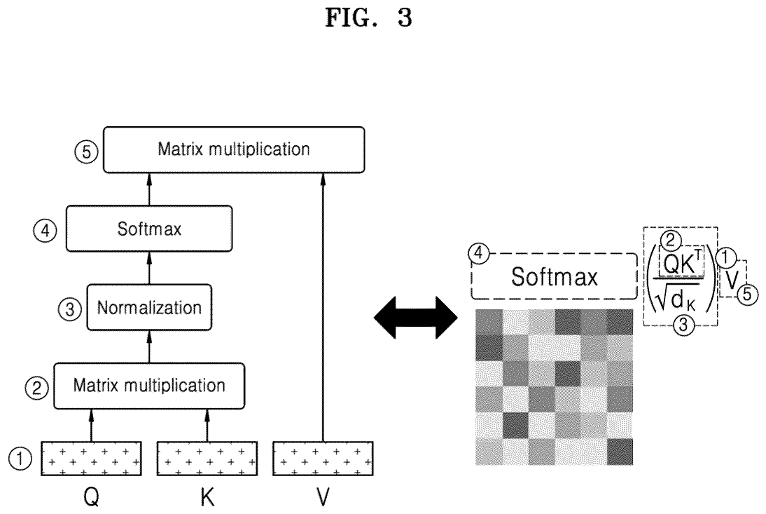

Considering the calculation of the guidance information in the AI network, by taking the calculation of the attention weight (attention map) as an example, most operations in the attention module will be occupied. For example, as shown in FIG. 3, the calculation process of the attention module includes 5 operations, among which the first four operations are used to generate the attention weight. In an embodiment, in the first operation, a query (Q) feature, a key (K) feature and a value (V) feature are acquired; in the second operation, the K feature is transposed and then subjected to matrix multiplication with the Q feature to generate a similarity matrix; in the third operation, the similarity matrix is normalized, for example, each element is divided by \sqrt{dₖ}, where dₖ is the dimension of K; in the fourth operation, the normalized result is processed by Softmax to obtain an attention weight; and, in the fifth operation, matrix multiplication is performed on the attention weight and the V feature. In order to accelerate the image processing process and facilitate the deployment on the mobile device, an embodiment aims to simplify the calculation of the spatial correlation guidance information and/or the semantic correlation guidance information. In an embodiment, the repeated calculation of the guidance information in the first AI network and the second AI network may be reduced, so that the guidance information in the processing process of the first AI network is obtained and shared to the second AI network, thereby saving the calculation of the guidance information in the second AI network.

In operation S102, super-resolution processing is performed on the first image based on the guidance information by using a second AI network to obtain a second image.

According to an embodiment, the first image obtained in the operation S101 may be a low-resolution image. In the operation S102, the second AI network may receive the low-resolution image obtained by the first AI network, the description of the input information and the guidance information in the first AI network as input and may transform the low-resolution image into a high-resolution image by using these pieces of information (e.g., super-resolution processing, which may also be called hyper-resolution processing), so that the generated second image may have a higher resolution while maintaining the original details of the first image.

In an example, the second AI network may be a super-resolution model (also called a hyper-resolution model), and the processing of this operation may depend on the image restoration and amplification capabilities of the second AI network. In an example, the second AI network may realize high-resolution image generation by using the diffusion process of at least one diffusion network model. In an example, the generation of a high-resolution and high-quality image may be realized by cascading two diffusion models. In an example, the type of the second AI network is not limited thereto, and the second AI network may also be other neural network models. The type and training mode of the second AI network may be set by those skilled in the art according to the type of images a user needs generated, and the embodiments of the present disclosure are not limited to these examples.

By the above method provided according to an embodiment, the user can input text, images, text plus images or other information and generate a high-resolution image that is highly consistent with the input intention, so that the field of application of the AI image edition technology is expanded, and the user's requirements for high-quality and high-resolution images may be greatly satisfied. In addition, by sharing the guidance information in the first AI network to the second AI network, the calculation of the guidance information in the high-resolution space (e.g., in the second AI network) is saved. Thus, the super-resolution processing process may be realized rapidly, the model size, calculation amount and time consumption are effectively reduced, and the user experience may be improved.

According to an embodiment, an optional implementation is provided for the operation S101. In an embodiment, the first AI network may include at least one first spatial attention module, and the spatial correlation guidance information may include the at least one piece of spatial correlation guidance information in the first spatial attention module.

The spatial correlation guidance information may be represented in the form of a self-attention weight map, but it is not limited thereto.

According to an embodiment, the first AI network may include at least one first spatial attention module. The spatial attention module may be specifically a self-attention block, but it is not limited thereto. In an example, the first spatial attention module may be a self-attention module using a Transformer model or may be spatial attention modules of other structures known to one of ordinary skill in the art. However, embodiments are not limited to these examples. The spatial correlation guidance information obtained from a plurality of first spatial attention modules may be interpreted as the spatial correlation guidance information in different stages, corresponding to different space sizes, which may be interpreted as different scales.

Since the spatial correlation guidance information reflects the correlation between image blocks, and the high-resolution image and the low-resolution image have the same semantic feature and are different only in spatial dimension (e.g., length and width dimensions, excluding channel dimension) and detail, the correlation between image blocks may be shared. According to an embodiment, when the spatial attention module is a self-attention module as an example, the self-attention weight of at least one stage of the relevant resolution generated by the first AI network is used as the spatial attention guidance information in the second AI network so that efficient self-attention is realized in the second AI network, and the calculation amount is advantageously saved.

In an embodiment, the obtained spatial correlation guidance information of at least one stage (e.g., the at least one piece of spatial correlation guidance information of the first spatial attention module) may be stored by using a spatial correlation guidance information cache pool (e.g., which may be specifically a self-attention weight cache pool) for subsequent acquisition and use by the second AI network.

According to an embodiment, the semantic correlation guidance information may include guidance information corresponding to at least one token.

The semantic correlation guidance information may be represented in the form of a cross-attention weight map, but it is not limited thereto.

According to an embodiment, the first AI network may include at least one first semantic attention module. The semantic attention module may be specifically a cross-attention block. In an embodiment, the first semantic attention module may be a cross-attention module using a Transformer model or may be semantic attention modules of other structures. However, embodiments are not limited thereto.

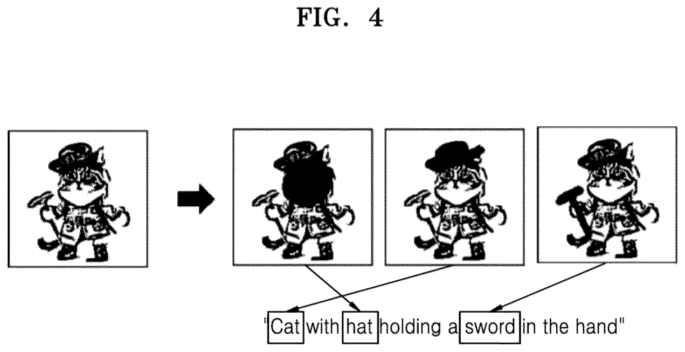

According to an embodiment, the semantic correlation guidance information may reflect the relationship between different modes. For example, by taking a text-to-image generation task as an example, the semantic correlation guidance information reflects the correlation between the text and the image. For example, the semantic correlation guidance information represents the correlation between tokens and pixels. The token may refer to the minimum grammatical unit in the language. For example, the token may refer to a character, a word, a vocabulary, etc. For example, as shown in FIG. 4, if the input text is “Cat with hat holding a sword in the hand”, the words “hat”, “Cat” and “sword” may be used as tokens, and the semantic correlation weight (e.g., the attention of token-image) between the token and any position of the whole map is obtained. In an example, if the input text is “Cat with hat holding a sword in the hand”, the words “Cat”, “hat” and “sword” may be used as tokens, and the semantic correlation weight between the token and any position of the whole map may be obtained.

In an example, the text content constraints may be obtained based on at least one token.

Since at least one token (e.g., the text information or image content input by the user) may provide a highly correlated semantic description of the image, this at least one token has great guidance significance for image generation and image super-resolution. Therefore, according to an embodiment, when the semantic attention module is a cross-attention module as an example, the cross-attention weight generated by the first AI network integrates the global correlation between the at least one token and the pixels of the image, and may be effectively incorporated into the second AI network according to the global semantic guidance information, thereby realizing the semantic guidance of the at least one token on the image super-resolution.

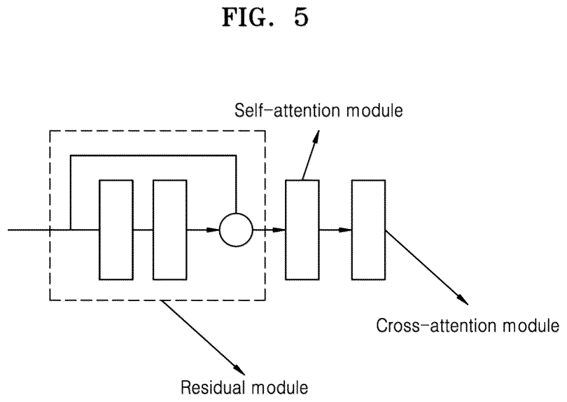

As understood by one of ordinary skill in the art, the sharing of the spatial correlation guidance information and the sharing of the semantic correlation guidance information may be used separately or in combination. Referring to one attention module shown in FIG. 5 as an example (the attention modules of other structures are similar), this attention module may include a residual network (Resnet) module, a self-attention module and a cross-attention module which are connected, and each of the first AI network and the second AI network includes a plurality of attention modules. Since the attention module has a great impact on the calculation time, no matter whether the self-attention weight in the self-attention module of the first AI network is shared to the second AI network, or the cross-attention weight in the cross-attention module of the first AI network is shared to the second AI network, or the self-attention weight in the self-attention module and the cross-attention weight in the cross-attention module in the first AI network are both shared to the second AI network, the calculation amount of the second AI network may be advantageously reduced. In addition, the order of sharing the spatial correlation guidance information and the semantic correlation guidance information may not be sequential, and may be set by those skilled in the art according to the type of images a user needs generated, and the embodiments of the present disclosure are not limited to these examples.

According to one or more embodiments, the second AI network includes at least one second spatial attention module and/or at least one second semantic attention module, the operation S102 may include at least one of the following.

In operation S1021, spatial attention processing is performed on an input first image feature based on the spatial correlation guidance information by using the at least one second spatial attention module.

In operation S1022, semantic attention processing is performed on an input second image feature based on the semantic correlation guidance information by using the at least one second semantic attention module.

As understood by one of ordinary skill in the art, from the above description that the operation numbers of the operations S1021 and S1022 do not constitute any limitation to the order of the two operations. For example, only one of the operations S1021 and 1022 may be executed, or the execution order of the operations S1021 and S1022 may not be sequential. For example, it is possible to execute the operation S1021 first and then the operation S1022, or execute the operation S1022 first and then the operation S1021, or execute the operation S1021 and the operation S1022 simultaneously. It will not be limited in the embodiment.

According to an embodiment, the first AI network includes at least one first semantic attention module, the semantic correlation guidance information includes semantic correlation guidance information corresponding to at least one token in the at least one first semantic attention module, and the operation S1022 may include: for each token, fusing the semantic correlation guidance information corresponding to this token in the at least one first semantic attention module to obtain semantic correlation guidance information corresponding to this token; and, performing semantic attention processing on the input second image feature based on the semantic correlation guidance information corresponding to at least one token by using the at least one second semantic attention module.

According to an embodiment, the semantic correlation guidance information obtained from different first semantic attention modules may be interpreted as the semantic correlation guidance information in different stages, corresponding to different space sizes, which may be interpreted as different scales. Each stage may include the semantic correlation guidance information corresponding to at least one token. Since the semantic feature is a global feature, the robustness and global performance of the obtained semantic correlation guidance information may be improved by comprehensively considering the semantic correlation guidance information of all stages in the image edition process of the first AI network.

Therefore, according to an embodiment, by superimposing the semantic correlation guidance information of each stage of the model in the image edition process of the first AI network, the global semantic correlation guidance information of each token corresponding to different positions of the image may be established. For example, the semantic correlation guidance information of the token-to-pixel level may be obtained.

In an embodiment, fusing the semantic correlation guidance information corresponding to this token in the at least one first semantic attention module (e.g., the processing mode for each token is different) may include: for each execution of the first AI network, transforming the semantic correlation guidance information corresponding to this token in the at least one first semantic attention module to the same size as the first image and then superimposing to obtain accumulated first semantic correlation guidance information; superimposing the accumulated first semantic correlation guidance information obtained by each execution of the first AI network to obtain accumulated second semantic correlation guidance information; and, normalizing the accumulated second semantic correlation guidance information and the accumulated first semantic correlation guidance information.

For example, in the process of editing the first image by the first AI network, the first AI network may execute one or more operations. According to an embodiment, for each token, the robustness and global performance of the cross-attention weight are improved by comprehensively considering the semantic correlation guidance information of all operations and all stages in the image edition process of the first AI network.

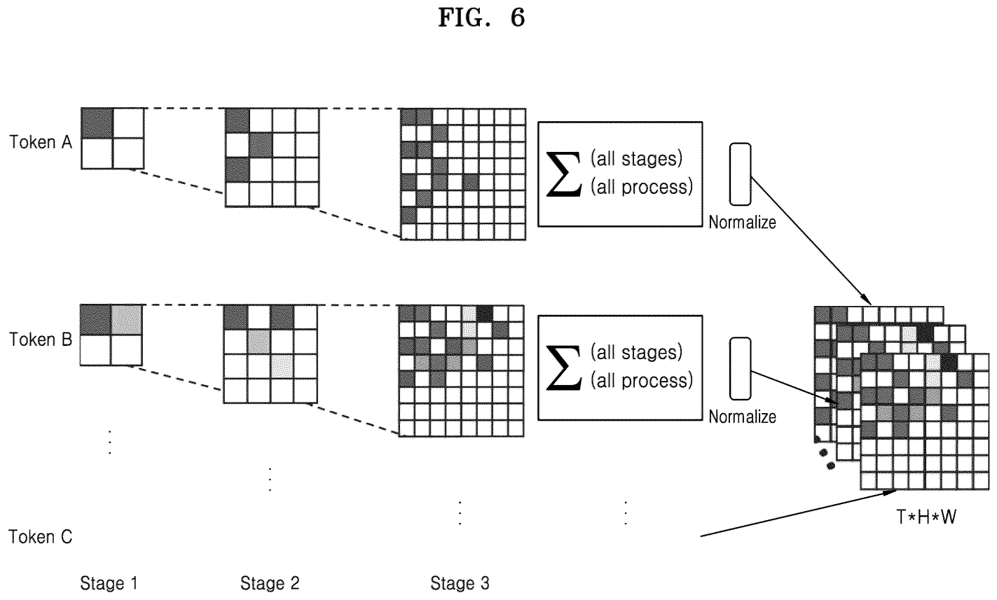

As an example, as shown in FIG. 6, when the semantic correlation guidance information is a cross-attention weight map as an example, it is assumed that multiple tokens such as Token A, Token B, Token C, etc., may be obtained from the input information of the user. For each token, in the image edition process of each operation of the first AI network, the cross-attention weight maps of all stages in the model are normalized to the same size (T×H×W) as the original image (first image) and then superimposed to obtain a cross-attention accumulated weight map (i.e., accumulated first semantic correlation guidance information) of each operation. Then, the cross-attention accumulated weight maps in all (operations) processes are superimposed during multiple executions of the first AI network. In order to maintain the weight in the range of 0 to 1, the final accumulated result (e.g., accumulated second semantic correlation guidance information) is divided by the number of operations*stages (e.g., normalization), so that the final cross-attention weight map of the token-to-pixel level corresponding to each of the multiple tokens Token A, Token B, Token C, etc. is obtained. The module that executes this process may be called a cross-attention weight fusion module, and this module may be included in the cross-attention module of the second AI network.

According to an embodiment, an optional implementation is provided for the operation S102. For example, the second AI network may include at least one second spatial attention module and/or at least one second semantic attention module, and the operation S102 may include at least one of the following.

In operation S102A, spatial attention processing is performed on the first image feature corresponding to the corresponding second spatial attention module based on the at least one piece of the spatial correlation guidance information in the first spatial attention module.

According to an embodiment, the stage of obtaining the spatial correlation guidance information generated by the first AI network (e.g., sharing the spatial correlation guidance information of which first spatial attention modules) and the corresponding stage (e.g., sharing to which second spatial attention modules) in the second AI network may be set. For the convenience of description and understanding, the following description will be given with the spatial attention module being a self-attention module as an example.

In an example, it is assumed that each of the first AI network and the second AI network includes five self-attention modules. The first self-attention module of the first AI network generates the self-attention weight of the first stage and corresponds to the first self-attention module in the second AI network, so that the self-attention weight of the first stage and the first image feature of the first self-attention module in the second AI network are fused. The remaining self-attention modules may be analogized in the same manner. For example, the self-attention modules of the same stages of the first AI network and the second AI network may share the self-attention weight.

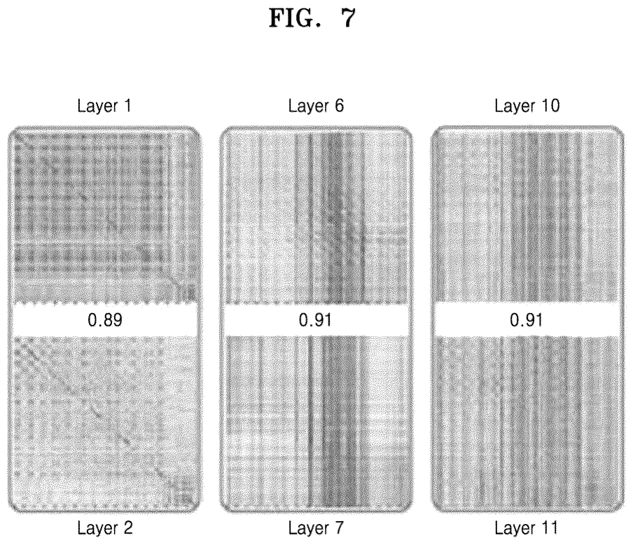

In an example, considering that the features of similar levels may be extracted in adjacent stages, the attention weights may also be similar, as shown in FIG. 7, so the self-attention modules in adjacent stages of the first AI network and the second AI network can also share the self-attention weight.

As an example, it is assumed that the first AI network includes seven self-attention modules and the second AI network includes five self-attention modules. The self-attention weights of five stages generated by the second to sixth self-attention modules of the first AI network are shared to the second AI network, and the second self-attention module of the first AI network generates the self-attention module of the second stage and corresponds to the first self-attention module in the second AI network, so that the self-attention weight of the second stage and the first image feature of the first self-attention module in the second AI network may be fused. The remaining self-attention modules are analogized in the same manner.

As described above, the first AI network and the second AI network may perform multiple executions. According to an embodiment, if the number of executions (operations) of the second AI network is the same as the number of executions of the first AI network, the self-attention weight of each operation of the first AI network may be shared to the second AI network of the corresponding operation. For example, the self-attention weight in the first execution of the first AI network is shared for use in the first execution of the second AI network, the self-attention weight in the second execution of the first AI network is shared for use in the second execution of the second AI network, and so on.

In an example, the number of executions of the second AI network may be less than the number of executions of the first AI network. In this scenario, the self-attention weights of multiple operations of the first AI network may be averaged and then shared to the second AI network of the corresponding operation. For example, if the first AI network iteratively executes edition 50 times to obtain the first image and the second AI network iteratively executes super-resolution processing 10 times to obtain the second image, the self-attention weights obtained by every five executions of the first AI network are averaged and then shared for use in one execution of the second AI network. In an example, the number of executions and correspondence of the first AI network and the second AI network may be set based on the type of images a user needs generated, and the embodiments of the present disclosure are not limited to these examples.

In practical applications, the number of the first spatial attention module in the first AI network, the number of the second spatial attention module in the second AI network, the spatial correlation guidance information generated by the first AI network for sharing to the second AI network and the correspondence of stages and operations may be set according to type of images a user needs generated, and the embodiments of the present disclosure are not limited to these examples.

In an example, the correspondence between stages is sequential. For example, the self-attention weight generated by a front stage in the first AI network will be shared to a front self-attention module of the second AI network, and the self-attention weight generated by a later stage in the first AI network will be shared to a later self-attention module of the second AI network. Therefore, according to an embodiment, the self-attention weights generated in the first AI network may be cached in a self-attention weight cache pool and recorded in their order for subsequent acquisition and use by the second AI network.

In an example, due to the flexibility of the correspondence between stages, in order to deal with the situation where the shared self-attention weight and the first image feature of the corresponding stage may be different in resolution, the self-attention weight generated by the first AI network may be resized and then adapted to the adaptation stage in the second AI network so as to match with the resolution of the first image feature of this stage, and then may be fused with the first image feature, so that the weight is adjusted in spatial dimension.

In operation S102B, the semantic correlation guidance information corresponding to at least one token is fused, and semantic attention processing is performed on the second image feature corresponding to the at least one second semantic attention module based on the fused semantic correlation guidance information.

According to an embodiment, the semantic correlation guidance information corresponding to at least one token may be fused to obtain the fused semantic correlation guidance information, and the fused semantic correlation guidance information may be fused with the feature (at least one second image feature) in the second AI network, so that the fused semantic correlation guidance information is incorporated into the feature of the second AI network.

It should be understood the operations S102A and S102B may be used separately or in combination. In addition, the execution order of the operations S102A and S102B may not be sequential and may be set by those skilled in the art according to the type of images a user needs generated, and the embodiments of the present disclosure are not limited to these examples.

According to an embodiment, an optional implementation is provided for the operation S102A. In an embodiment, for each spatial correlation guidance information in the first spatial attention module, performing, based on the spatial correlation guidance information, spatial attention processing on the first image feature corresponding to the corresponding second spatial attention module may include the following operations.

In operation S102A1, a fourth image feature and a fifth image feature may be obtained based on the first image feature corresponding to the corresponding second spatial attention module.

According to an embodiment, the first image feature may be processed into two parts for execution of subsequent operations S102A2 and S102A3 in parallel to realize the adjustment of channel attention, thereby realizing high-quality self-attention in the second AI network and greatly saving the calculation amount. In practical applications, those skilled in the art can select an appropriate mode to process the first image feature into two parts according to the type of images a user needs generated, and the embodiments of the present disclosure are not limited to these examples.

As an example, the first image feature of the corresponding stage in the second AI network may be split into two parts. For example, the first image feature of the corresponding stage in the second AI network may be divided into two parts in the channel dimension. Thus, a fourth image feature and a fifth image feature may be obtained, and the amount of parallel calculation is reduced without basically affecting the calculation effect. In an example, the first image feature of the corresponding stage in the second AI network may be copied to obtain a fourth image feature and a fifth image feature (e.g., the two image features are the same), thereby advantageously resulting in more complete calculation data.

In operation S102A2, the spatial correlation guidance information is fused with the fourth image feature to obtain a sixth image feature.

This operation may be interpreted as follows: by using the spatial correlation guidance information generated by the first spatial attention module corresponding to this stage in the first AI network, the matrix multiplication is performed on a spatial attention branch and the input fourth image feature to obtain the sixth image feature subjected to global spatial attention adjustment.

In operation S102A3, channel attention adjustment is performed on the fifth image feature to obtain a seventh image feature.

This operation may be interpreted as a channel attention branch. Different channels in the image feature may be interpreted as information of different frequencies. In an example, a frequency may correspond to a number of times an image feature appears in an image. According to the characteristics of the super-resolution processing task of the second AI network, during image amplification, the semantic information of the original low-resolution image (first image) is preserved, and more details and texture information are generated, which is manifested as the generation of high-frequency information on the image. For example, the super-resolution processing task pays great attention to the high-frequency information. Therefore, different channels may be differently weighted by using the channel attention mechanism provided in the spatial attention module, thereby better helping the network to learn the high-frequency information.

According to an embodiment, the channel attention weight of the fifth image feature may be preset, or the channel attention weight of the fifth image feature may be calculated based on the fifth image feature. In an embodiment, the fifth image feature may be compressed in the spatial dimension to obtain an eighth image feature. For example, the fifth image feature is pooled in the spatial dimension to obtain an eighth image feature having a spatial dimension of 1 and the same number of channels as the fifth image feature. The channel attention weight of the fifth image feature is obtained based on the eighth image feature. For example, a convolution operation (e.g., conv 1×1) is performed on the eighth image feature to obtain the channel attention weight of the fifth image feature, wherein the feature obtained by the convolution operation is used to represent the significance of each channel in the fifth image feature. Further, it is also possible to perform nonlinear mapping on the feature obtained by the convolution operation to obtain the channel attention weight of the fifth image feature.

Further, channel attention adjustment is performed on the fifth image feature based on the channel attention weight. For example, the channel attention weight may be multiplied with the original fifth image feature to weight different channels of the fifth image feature, so as to obtain a seventh image feature subjected to channel attention weight adjustment.

In operation S102A4, the sixth image feature is fused with the seventh image feature.

The fusing of the sixth image feature and the seventh image feature may correspond to the processing the first image feature into two parts.

As an example, if the fourth image feature and the fifth image feature are obtained by dividing the first image feature into two parts in the channel dimension, the sixth image feature and the seventh image feature may be spliced in the original order in the channel dimension, thereby ensuring that the spliced result is consistent with the first image feature in dimension. In an example, if the fourth image feature and the fifth image feature are obtained by copying the first image feature, the sixth image feature and the seventh image feature may be subjected to summation, averaging, weighted summation or other operations. Those skilled in the art can select an appropriate fusion mode according to the type of images a user needs generated, and the embodiments of the present disclosure are not limited to these examples.

In an embodiment, the spatial attention branch and the channel attention branch may also be executed in series. For example, the spatial attention branch may be executed first, and then process the output result of the spatial attention branch through the channel attention branch. In an example, the channel attention branch may be executed first and then process the output result of the channel attention branch through the spatial attention branch, and so on. Those skilled in the art can expand according to the type of images a user needs generated, and the embodiments of the present disclosure are not limited to these examples.

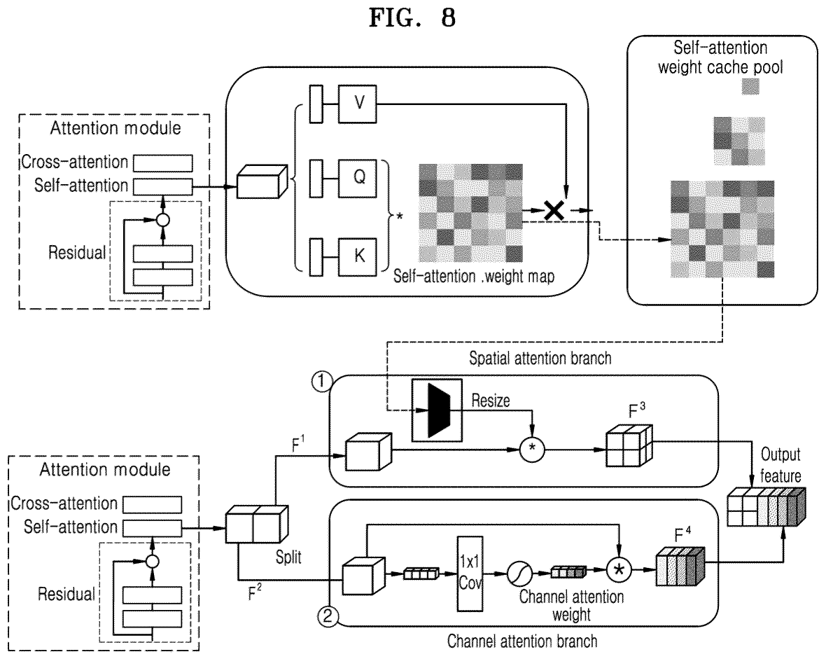

Based on at least one of the above embodiments, by taking the spatial correlation guidance information being a self-attention weight as an example, FIG. 8 shows a process example of sharing the self-attention weight according to an embodiment. For example, in the self-attention module of one attention module (including a residual module, a self-attention module and a cross-attention module which are connected) of the first AI network, a V feature, a Q feature and a K feature of the input feature are acquired. A self-attention weight map may be obtained according to the result of the matrix multiplication of the Q feature and the K feature, and the output result of the self-attention module may be obtained by multiplying the self-attention weight map with the V feature. The self-attention weight map is also saved in the self-attention weight cache pool for acquisition and use by the second AI network.

In an example, in the self-attention module of one attention module (including a residual module, a self-attention module and a cross-attention module which are connected) of the second AI network, the input feature is divided into two parts in the channel dimension, e.g., a feature F¹ (e.g., the fourth image feature) and a feature F² (e.g., the fifth image feature).

In an example, the feature F is input into the spatial attention branch. The self-attention weight map generated by the self-attention module in the first AI network corresponding to this stage is obtained from the self-attention weight cache pool, and the self-attention weight map is resized to be consistent with the input feature in the spatial dimension. Matrix multiplication is performed on the feature F and the resized self-attention weight map to obtain a feature F³ (i.e., the sixth image feature) subjected to global spatial attention adjustment. The feature adjustment mode may be directly resizing, or may be dimension adjustment by convolution.

In an example, the feature F² is input into the channel attention branch. Firstly, the feature F² is pooled in the spatial dimension to obtain a feature having a spatial dimension of 1 and the same number of channels as F². After 1×1 convolution and nonlinear layer are performed on this feature, the attention weight in the channel dimension is obtained. The channel attention weight is multiplied with the original feature F² to weight different channels, so as to obtain a feature F⁴ (e.g., the seventh image feature) subjected to channel attention weight adjustment.

The F³ and F⁴ are spliced in the original order in the channel dimension to generate an output feature, thereby ensuring that the output feature is consistent with the input feature in dimension.

The spatial attention branch and the channel attention branch may constitute a self-attention fusion module. This module may be included in the self-attention module.

According to an embodiment, the self-attention fusion module may realize the global spatial attention adjustment of the feature in the second AI network by using the self-attention weight map shared by the first AI network, the feature of the associated region may be referenced according to the correlation, and a higher channel attention weight may be given for the high-frequency feature channel through the feature attention branch parallel to the spatial attention, so that a high-quality and high-resolution image may be generated and lots of operations are saved.

According to an embodiment, for the operation S102B, fusing the semantic correlation guidance information corresponding to at least one token may specifically include the following operations.

In operation S102B1, the weight corresponding to the at least one token is acquired.

The dimension of the acquired weight (which may be called a token aggregation weight, for the convenience of distinguishing) is consistent with the number of tokens.

In an example, the token aggregation weight may be the default weight and may be set by those skilled in the art according to the type of images a user needs generated, and the embodiments of the present disclosure are not limited to these examples.

In an example, the token aggregation weight may also be user-defined. In an embodiment, it is possible to display at least one token through an electronic device, and determine the weight corresponding to the at least one token in response to the user's first selection operation to the target token in the at least one token. The display mode may include, but not limited to, text, voice, etc., and the selection mode includes, but not limited to, clicking, speaking, etc. For example, According to an embodiment, the user may select, according to at least one token corresponding to the original input information, a token for which the user wants to generate more details. It should be understood that more weights may be allocated for the token selected by the user. In practical applications, the allocation proportion of the token selected by the user and the token not selected by the user may be set according to the type of images a user needs generated, and the embodiments of the present disclosure are not limited to these examples.

In operation S102B2, weighted fusion may be performed on the semantic correlation guidance information corresponding to the at least one token based on the weight corresponding to the at least one token.

For example, by taking the semantic correlation guidance information being a cross-attention weight as an example, matrix multiplication and weighting may be performed on the cross-attention weight corresponding to at least one token and the weight corresponding to the at least one token, to obtain the fused cross-attention weight.

According to an embodiment, for the operation S102B, performing, based on the fused semantic correlation guidance information, semantic attention processing on the second image feature corresponding to the at least one second semantic attention module may include: fusing the fused semantic correlation guidance information with a third image feature of at least one scale corresponding to the first image to obtain a global semantic feature of at least one scale; and, performing, based on the global semantic feature of at least one scale, semantic attention processing on the second image feature corresponding to the second semantic attention module of the corresponding scale.

The third image feature may refer to the image feature obtained by performing feature extraction on the first image. In an example, the first image may be input into a feature extraction network (e.g., a lightweight convolution network) including a plurality of feature extraction modules to extract the third image feature from the first image. The third image feature of different scales (which may be interpreted as different stages, e.g., being output by different feature extraction modules, corresponding to different space sizes) in the feature extraction network may be fused with the semantic correlation guidance information corresponding to at least one token to obtain the global semantic feature of at least one scale. For example, by taking the semantic correlation guidance information being a cross-attention weight as an example, for the third image feature of each stage corresponding to the first image, matrix multiplication is performed on the third image feature and the resized and fused cross-attention weight to obtain the global semantic feature of this stage.

In an embodiment, semantic attention processing is performed on the global semantic feature of each scale and the feature (e.g., the second image feature of the corresponding scale) in the second AI network, so that the global semantic feature may be incorporated into the feature of the second AI network.

In an embodiment, the number of the first semantic attention module in the first AI network, the number of the second semantic attention module in the second AI network, the semantic correlation guidance information generated by the first AI network for sharing to the second AI network and the second semantic attention module to be incorporated with the global semantic information in the second AI network may be set according to the type of images a user needs generated, and the embodiments of the present disclosure are not limited to these examples.

In operation S102B3, the fused semantic correlation guidance information may be fused with the third image feature of at least one scale corresponding to the first image.

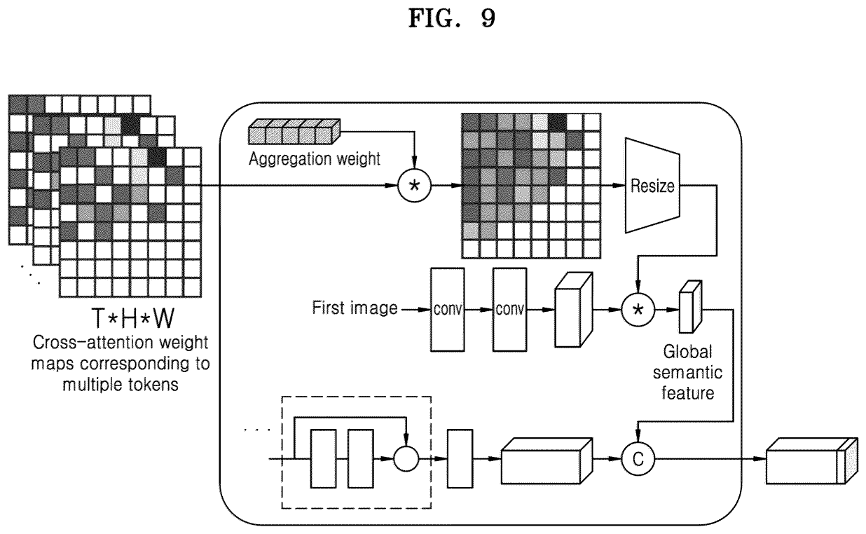

Based on at least one of the above embodiments, when the semantic correlation guidance information is a cross-attention weight as an example, FIG. 9 shows a process example of sharing the cross-attention weight according to an embodiment. For example, after the cross-attention weight maps of the token-to-pixel level corresponding to a plurality of tokens are obtained, the cross-attention weight maps are subjected to matrix multiplication and weighting by using a token aggregation weight to obtain a fused cross-attention weight map. The first image is input into a feature extraction network (e.g., a convolution (conv) network) to extract an image feature from the first image, and matrix multiplication is performed on the features of different stages (e.g., different space sizes) in the feature extraction network and the resized and fused cross-attention weight map, to obtain a global semantic feature of the corresponding stage. The global semantic feature of each stage is fused with the feature (e.g., the third image feature) of the same feature space size in the second AI network, so that the global semantic information is incorporated into the feature of the second AI network. The module that executes this process may be called a cross-attention fusion module, and this module may be included in the cross-attention module.

According to an embodiment, since the second AI network has the same semantic meaning as the first AI network, the cross-attention weight may be reused in the second AI network. By accumulating all cross-attention weights shared by the first AI network, the cross-attention weight of the token-to-pixel level may be obtained. The cross-attention fusion module may incorporate the shared semantic information into the second AI network through an ultra-lightweight encoder by using the cross-attention weight, thereby ensuring the consistence of the semantic information of the high-resolution image (e.g., the second image) and the semantic information of the original low-resolution image (e.g., the first image). After the feature in the second AI network is adjusted, the guidance of the global semantic information to hyper-resolution may be realized, so that the second AI network can generate natural and real texture details.

According to an embodiment, the second AI network may include a correction module, and the operation S102 may include: performing, by using the correction module, feature correction in a row direction and/or column direction of the image feature corresponding to the first image.

In an example, the first AI network may perform image edition according to the guidance of the input information, wherein the input information may be the highly generalization of the semantic meaning which may guide the first AI network to generate the content with correct semantic meaning, but may not contain rich visual texture information, so that the first AI network may generate details that do not completely match with the natural image in detail texture.

For human observation, the regular texture is obvious if it is misaligned. However, these details themselves are not obvious in a low-resolution image, but the misaligned details will be enlarged due to the super-resolution processing process, thus, disadvantageously affecting the user's visual perception.

Since human eyes are particularly sensitive to the alignment of regular features in the row direction and column direction, in order to avoid the situation where the poor detail texture in the generated low-resolution image (e.g., the first image) will be enlarged in the super-resolution processing process, it is difficult for the user to accept the misalignment that is not obvious itself. According to an embodiment, the correction module automatically corrects misaligned texture features by calculating the relationship between features in the row direction (horizontal direction) and/or column direction (vertical direction), so that the visual effect of the high-resolution image may be greatly improved.

The correction module may be connected before the attention fusion module, and in this case, the image feature corresponding to the first image refers to the feature obtained by directly performing feature extraction on the first image; In an example, the correction module may be connected behind the attention fusion module, and in this case, the image feature corresponding to the first image may refer to the feature obtained after performing certain super-resolution processing on the first image. In an example, the correction module may be arranged before and behind the attention fusion module, and the image feature corresponding to the first image may include the above two situations and may be processed separately.

In an example, feature correction may be performed in the row direction and/or column direction of the image feature corresponding to the first image by using dilated convolution.

Compared with that the ordinary convolution may only use a small receptive field to obtain the relationship between adjacent square regions, the correction module may realize the strong correlation correction of features in the row direction and/or the strong correlation correction of features in the column direction by using dilated convolution with a large receptive field in the row direction and/or column direction, thereby achieving the effect of correcting misaligned texture generated for the first AI network in the second AI network to repair the misalignment in the human eye sensitive structure.

In an embodiment, feature correction is performed in the row direction and/or column direction of the image feature corresponding to the first image by cascaded dilated convolutions with at least two dilation indexes.

In an example, the dilated convolutions with at least two dilation indexes may be connected in series.

In an example, the number of the dilated convolutions connected in series may be adjusted according to the feature dimension.

In an example, the dilation index corresponding to each dilated convolution may be adjusted according to the type of images a user needs generated.

In an example, the dilation indexes of the dilated convolutions connected in series may increase progressively.

In an example, performing, by using dilated convolution, feature correction in the row direction and/or column direction of the image feature corresponding to the first image may include the following operations.

In operation S301, a ninth image feature and a tenth image feature may be determined based on the image feature corresponding to the first image.

According to an embodiment, feature correction in the row direction and the column direction may be realized by processing the image feature corresponding to the first image into two parts. In practical applications, those skilled in the art can select an appropriate mode to process the image feature corresponding to the first image feature into two parts according to the type of images a user needs generated, and the embodiments of the present disclosure are not limited to these examples.

As an example, the image feature corresponding to the first image may be split into two parts. For example, the image feature corresponding to the first image is divided into two parts in channel dimension. Thus, a ninth image feature and a tenth image feature may be obtained, and the calculation amount is reduced without basically affecting the calculation result. In an example, the image feature corresponding to the first image may be copied to obtain a ninth image feature and a tenth image feature (e.g., the two image features are the same), so that the calculation data is more complete.

In operation S302, the ninth image feature is compressed in the row direction, and dilated convolution is performed on the compressed ninth image feature in the column direction for at least one time to obtain the corrected image feature in the column direction.

In an example, the ninth image feature may be globally pooled in the row direction to compress the ninth image, so as to obtain the compressed ninth image having a dimension of column*channel number.

In an embodiment, dilated convolution is then performed on the compressed ninth image feature for at least one time in the column direction. For example, feature extraction may be performed by a plurality of dilated convolution connected in series with different dilation indexes. Thus, the perception of the global range in the column direction may be realized, and the corrected image feature in the column direction may be obtained.

In an example, the ninth image feature after the dilated convolution in the column direction may be copied in the row dimension, and the expansion dimension is the same as that of the original ninth image feature. In an embodiment, matrix multiplication is performed on the ninth image feature with the expanded dimension and the original ninth image feature to obtain the corrected image feature in the column direction.

In operation S303, the tenth image feature may be compressed in the column direction, and dilated convolution is performed on the compressed tenth image feature in the row direction for at least one time to obtain the corrected image feature in the row direction.

In an example, the tenth image feature may be globally pooled in the row direction to compress the tenth image, so as to obtain the compressed tenth image having a dimension of row*channel number.

In an embodiment, dilated convolution may be then performed on the compressed tenth image feature for at least one time in the row direction. For example, feature extraction may be performed by a plurality of dilated convolution connected in series with different dilation indexes. Thus, the perception of the global range in the row direction is realized, and the corrected image feature in the row direction may be obtained.

The tenth image feature after the dilated convolution in the row direction may be copied in the column dimension, and the expansion dimension is the same as that of the original tenth image feature. In an embodiment, matrix multiplication is performed on the tenth image feature with the expanded dimension and the original tenth image feature to obtain the corrected image feature in the row direction.

In operation S304, the corrected image features may be fused.

The way of fusing the corrected and aligned image features may correspond to the way of processing the image feature corresponding to the first image into two parts.

As an example, if the tenth image feature and the tenth image feature are obtained by dividing the image feature corresponding to the first image into two parts in the channel dimension, the corrected and aligned image features may be spliced in the channel dimension. In an example, if the ninth image feature and the tenth image feature are obtained by copying the image feature corresponding to the first image, the corrected and aligned image features may be subjected to summation, averaging, weighted summation or other operations. Those skilled in the art can select an appropriate fusion mode according to the type of images a user needs generated, and the embodiments of the present disclosure are not limited to these examples.

In an embodiment, the row alignment correction and the column alignment correction may also be executed in series. For example, it is possible to correct the row texture feature first and then correct the column texture feature of the row alignment result; In an example, it is possible to correct the column texture feature first and then correct the row texture feature of the column alignment result. Those skilled in the art can expand according to the type of images a user needs generated, and the embodiments of the present disclosure are not limited to these examples.

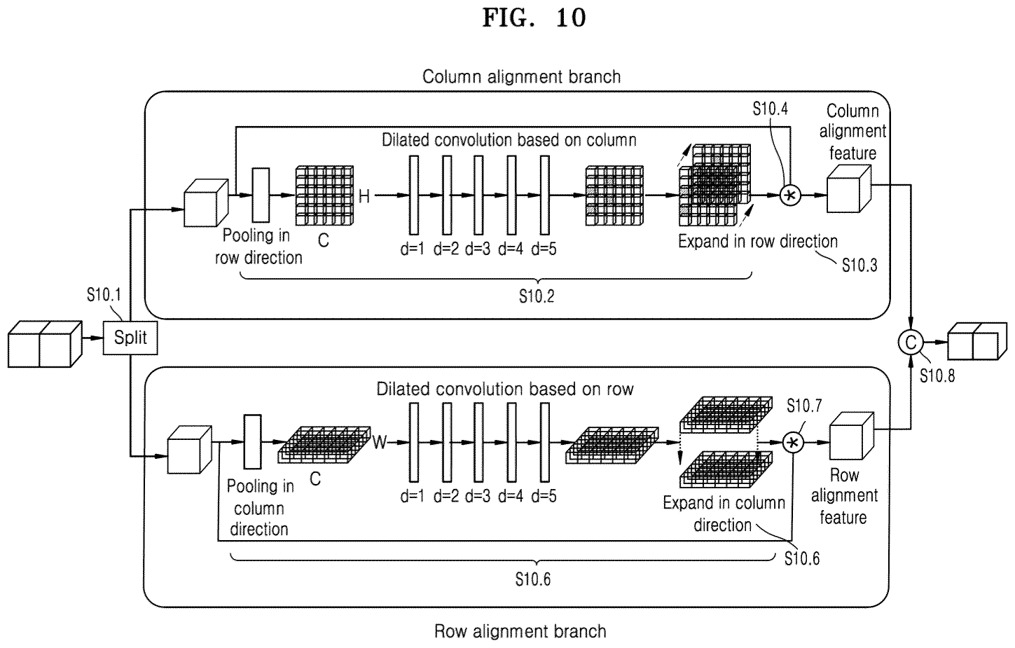

Based on at least one of the above embodiments, FIG. 10 shows a processing process example of the correction module according to an embodiment. The processing process may include the following operations.

In operation S10.1, the input feature is equally divided into two parts in the channel dimension, where one part is input to the row alignment branch and the other part is input into the column alignment branch.

In operation S10.2, on the column alignment branch, the input feature of the column branch is globally pooled to obtain a feature with a dimension of column (H)*channel (C) number, and feature extraction is then performed on the globally pooled feature by dilated convolution connected in series with a plurality of different dilation indexes, thereby realizing the perception of the global range in the column direction. FIG. 10 shows the dilated convolutions connected in series with five gradually increasing dilation indexes, which can cover the range of 13 intervals at most.

In operation S10.3, the feature obtained after a plurality of dilated convolutions by the column alignment branch is copied in the row dimension, and the expansion dimension is the same as that of the input feature of the column branch.

In operation S10.4, matrix multiplication is performed on the feature with the expanded dimension and the input feature of the column branch to obtain the corrected and aligned feature in the column direction.

In operation S10.5, on the row alignment branch, the operation is basically the same as the operation 10.3, except for the difference that the input feature of the row branch is globally pooled in the column direction to obtain a feature with a dimension of row (W)*channel (C) number.

In operation S10.6, the feature obtained after a plurality of dilated convolutions by the row alignment branch is copied in the column dimension, and the expansion dimension is the same as that of the input feature of the row branch.

In operation S10.7, matrix multiplication is performed on the feature with the expanded dimension and the input feature of the row branch to obtain the corrected and aligned feature in the row direction.

In operation S10.8, the output features of the two branches are spliced in the channel dimension to obtain the final result.

According to an embodiment, by performing correction in the row direction and/or column direction by the correction module and by the interaction in the feature level, the misalignment in the row and column directions is automatically corrected, and the super-resolution effect of the regular texture is improved. Thus, on the premise that human eyes are most sensitive to the regular texture, the visual perception of human eyes is enhanced, and the user experience is improved.

According to an embodiment, it is also possible to compress the image to a hidden variable space (which is also referred to as a potential space) by using a variational auto-encoder (VAE). The image edition process and/or the image ultra-resolution processing process is carried out in the potential space, so that the dimension of the model may be significantly reduced, such that the image edition process and/or the image ultra-resolution processing process is faster.

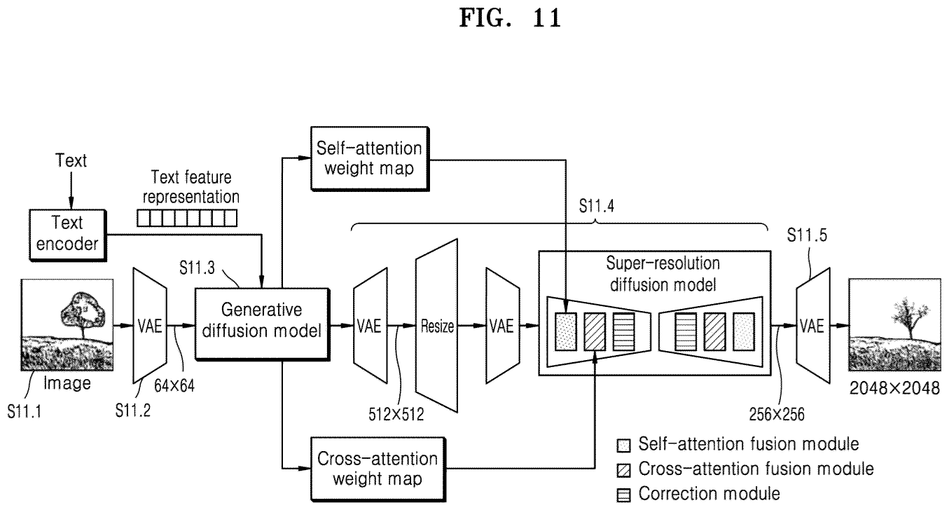

Based on at least one of the above embodiments, FIG. 11 shows a processing scheme of a high-performance and high-efficiency cascaded diffusion model according to one or more embodiments, which is used to generate a high-resolution image. In an embodiment, this scheme may include the following operations.

In operation S11.1, the user edits the original image, selects a removal region (e.g., “crown”) and inputs text to guide the model to generate the corresponding content.

In operation S11.2, the image (512×512) is compressed to the hidden variable space (64×64, settable) through a VAE network encoder and then encoded in combination with the text through a text encoder to obtain text feature representation, the generative diffusion model (i.e., the first AI network) may be guided to generate a low-resolution image (i.e., the first image), and the low-resolution image may be decoded to the original image form (512×512) through a VAE network decoder.

In operation S11.3, the self-attention weight map and the cross-attention weight map in the generative diffusion model are acquired.

In operation S11.4, the low-resolution image is resized and then compressed to the hidden variable space (256×256) through the VAE network encoder, the self-attention fusion module and the cross-attention fusion module in the super-resolution diffusion model (i.e., the second AI model) generate a high-resolution image based on the generated low-resolution image and attention map, and the high-resolution image is corrected in the row and column directions through the correlation module in the super-resolution diffusion model.

In operation S11.5, the high-resolution image is decoded to the original image form (2048×2048) through the VAE network decoder, and the final high-resolution image (i.e., the second image) is output.

According to an embodiment, by using the attention sharing mechanism between the generative diffusion model and the super-resolution diffusion model, the calculation in the high-resolution space may be saved, and the texture alignment generated by the generative diffusion model may be repaired.

In addition, since the self-attention module and the cross-attention module have different functions, the corresponding self-attention weights and cross-attention weights may be shared in different ways.

As seen from the above description of the self-attention fusion module that the adjacent calculated global spatial attention map may be used in the super-resolution diffusion model, thereby avoiding huge calculation in the high-resolution space and obtain the spatial self-attention. The spatial attention adjustment of the feature may be realized by resizing. It is also possible to realize channel attention adjustment through the channel weighting branch according to the characteristics of the super-resolution task, thereby better helping the network to learn high-frequency information, enhancing the super-resolution performance and further saving the calculation amount.

As seen from the above description of the cross-attention fusion module that, in the cross-attention weight map accumulated in the generative diffusion model, tokens may be guided and incorporated into the super-resolution, thereby ensuring the semantic consistence and enhancing the capability of the super-resolution diffusion model.

As seen from the above description of the correction module that the local correction module is based on a large receptive field module of columns and rows and used to extract horizontal and vertical relative features, and thus can correct the generated texture misalignment, particularly for human-sensitive regular texture, for example, horizontal or vertical texture, thereby realizing the high-quality super-resolution processing process.

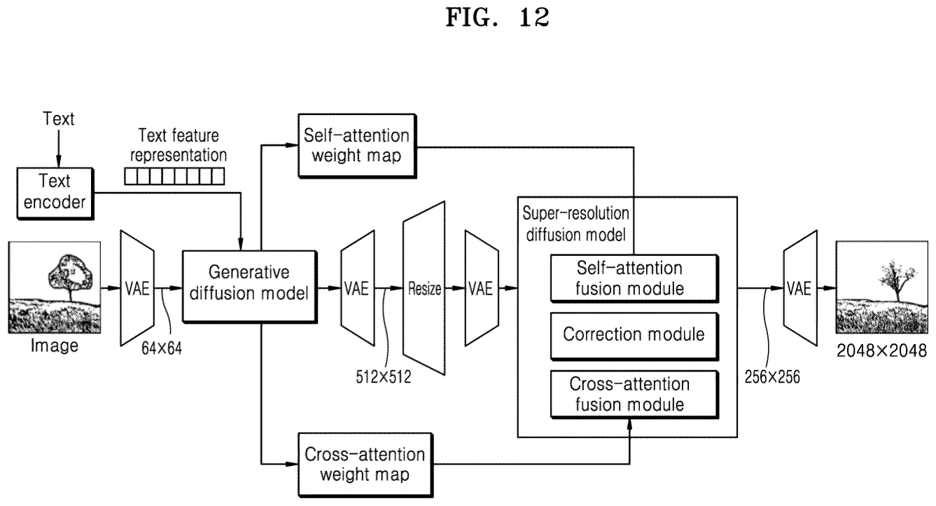

In practical applications, the connection among the self-attention fusion module, the cross-attention fusion module and the correction module in the super-resolution diffusion model is not limited to the structure shown in FIG. 11, and may adopt other connection modes, as shown in FIG. 12, and the above functions may be realized as long as the super-resolution diffusion model includes the three modules (possibly one or more). In addition, the three modules may be used separately or combined in pairs to realize the corresponding functions, and those skilled in the art can combine them according type of images a user needs generated, and the embodiments of the present disclosure are not limited to these examples.

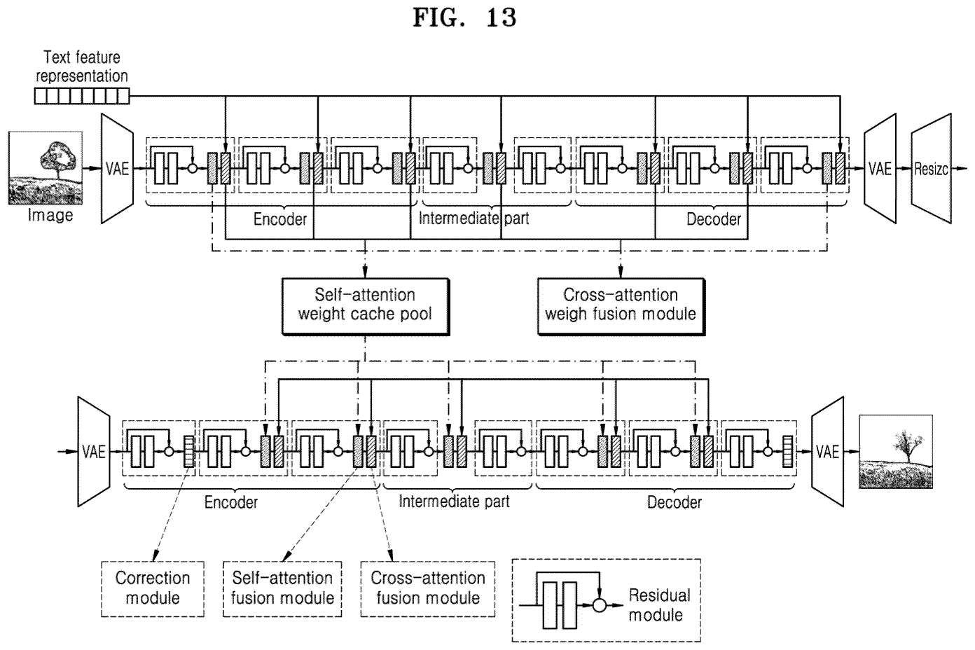

Based on at least one of the above embodiments, FIG. 13 shows a network structure for realizing high-resolution image generation by a cascaded diffusion model according to an embodiment, in which the whole structure is a U-net (e.g., a network with jump connections) based structure, including an encoder, an intermediate part and a decoder. The encoder may extract features by scaling the feature size, the intermediate part may be a further operation of enriching features, and the decoder may expand the space size to the image size. In combination with the features of the encoder, the residual module (Resnet) block may be used for feature extraction in each stage. The local correction module may be located in the shallow layer because it is very light and can repair texture details. The self-attention fusion module and the cross-semantic fusion module may be successively located behind the residual module in each stage.

In an embodiment, in FIG. 13, the upper model may be a generative diffusion model, which aims to generate a low-resolution image according to the input text, image, or text and image. In the image generation process:

The self-attention weight maps of the corresponding stages (the first, second, third, sixth and seventh stages are taken as an example in FIG. 13) acquired from each self-attention module of the generative diffusion model may be cached in the self-attention weight cache pool for subsequent use by the super-resolution diffusion model.

All cross-attention weight maps of the corresponding stages (e.g., the first to seventh stages are taken as an example in FIG. 13) acquired from each cross-attention module of the generative diffusion model may be accumulated by the cross-attention weight fusion module for subsequent use by the super-resolution diffusion model.

In addition, the lower model may be a super-resolution diffusion mode, which aims to perform super-resolution processing according to the low-resolution image to obtain a high-resolution image. In the image super-resolution process:

In an example, the self-attention fusion module in the super-resolution diffusion model may use the self-attention map in the self-attention weight cache pool, and the self-attention map may be resized, then adapted to the corresponding stage (the second, third, fourth, fifth and sixth stages are taken into as an example in FIG. 13, which are adjacent stages of the self-attention weight map acquired from the generative diffusion model) in the super-resolution model and fused with the feature output by the residual model, thereby realizing the adjustment of the weight in the spatial scale. Meanwhile, according to the characteristics of the super-resolution task, a dual-branch structure may be used to execute the channel attention mechanism in parallel to differently weight different channels automatically, thereby realizing the channel attention adjustment and better helping the network to learn the high-frequency information.

In an example, the cross-attention fusion module in the super-resolution diffusion model may resize all cross-attention accumulated weight maps in the image generation process, establish the cross-attention weight maps of each token corresponding to different positions of the image and incorporates them into the feature output by the self-attention module, thereby realizing the guidance of the semantic information to the feature in the super-resolution diffusion model.

In an example, the correction module in the super-resolution diffusion model realizes the strong correlation correction of features in the row direction and the strong correlation correction of features in the column direction by using cascaded dilated convolution in the row and column directions, thereby achieving the effect of correcting the misaligned texture generated for the generative diffusion model in the super-resolution diffusion model.

induplicate features of FIG. 13 with respect to FIG. 11 may be found in the description of FIG. 11 and the above embodiments, and will not be repeated here.

It is to be noted that the number and connection order of the self-attention module, the cross-attention module and the correction model in the cascaded diffusion model are optional. For example, only one correction module may be used in the decoder layer; for another example, by taking the residual unit, the self-attention module and the cross-attention module being a group of modules as an example, the decoder and the encoder may use a group of modules, respectively; for another example, the self-attention module may be connected behind the cross-attention module; and so on. Those skilled in the art can select and connect the modules according to the type of images a user needs generated, and the embodiments of the present disclosure are not limited to these examples.

By combining these modules, while ensuring the quality of the generated super-resolution image, the calculation amount of the attention module based on the diffusion model is reduced, the operation efficiency is optimized, the misaligned detail information is corrected, and high-quality and high-resolution image generation is realized rapidly.

According to an embodiment, before the operation S101, the method may further include the following operations.

In operation S001, in response to the user's input operation, target content text may be acquired.

In an embodiment of the application, the user may input the content of the image to be generated, and the input mode includes, but not limited to, text, image, voice, etc. In response to the user's input operation, the target content text corresponding to the input content of the user may be acquired. If the input is a voice content, the target content text obtained after converting the voice content into text may be acquired; and, if the input is an image, the target content text obtained by parsing the semantic meaning of the image may be acquired.

In operation S002, a corresponding recommended content constraint may be determined based on the target content text, and the recommended content constraint may be displayed.

According to an embodiment, the recommended content constraint determined based on the target content text may be provided to the user, wherein the recommended content constraint is a descriptive hint of the image and is helpful for the improvement of the image generation performance.

In an example, the recommended content constraint may include a positive content constraint, i.e., a positive descriptive hint, such as “high quality”, “meticulous clothing” and “real style”, and/or a negative content constraint, i.e., a negative descriptive hint, such as “low quality”, “oil painting” and “fussy”, and so on.

In an example, the text content constraint may be obtained based on the recommended content constraint and/or token.

In operation S003, in response to the user's second selection operation to the target content constraint in the recommended content constraint, the target content constraint and the target content text may be determined as input information.

According to an embodiment, the user may select one or more of the displayed recommended content constraints. For the positive descriptive hint selected by the user, the corresponding feature may be enhanced in the subsequent image generation and image super-resolution processing process. For the negative descriptive hint selected by the user, the corresponding feature may be subtracted in the subsequent image generation and image super-resolution processing process to achieve the purpose of personalized image quality improvement.

According to an embodiment, after the operation S101 of obtaining the first image based on the input information by using the first AI network, the method may include the following operations.

In operation S401, the first image may be displayed.

In operation S402A, a super-resolution processing instruction fed back by the user may be received.

The operation S102 may include: in response to the super-resolution processing instruction, performing super-resolution processing on the first image based on at least one of the spatial correlation guidance information and the semantic correlation guidance information by using the second AI network.

In an embodiment, the method may include the following operations.

In operation S402B, a first image reacquisition instruction fed back by the user may be received; and, in response to the first image reacquisition instruction, the operation of obtaining the first image based on the input information by using the first AI network and re-displaying the first image may be re-executed.

In an example, the user may be inquired whether the user is satisfied with the first image; if the user selects SATISFIED, the super-resolution processing instruction is fed back; and, if the user selects UNSATISFIED, the first image reacquisition instruction is fed back. In other embodiments, the two instructions may be generated in other ways, for example, displaying “Continue or not” or directly receiving the instruction input by the user, etc. However, embodiments are not limited thereto.

According to an embodiment, if the user is unsatisfied with the generated first image, the first AI network may be reused to generate the first image until the user is satisfied, and the attention weight in the processing process of the first AI network corresponding to the first image satisfied by the user is acquired and then shared to the second AI network for use, thereby improving the generation efficiency of the high-resolution image.

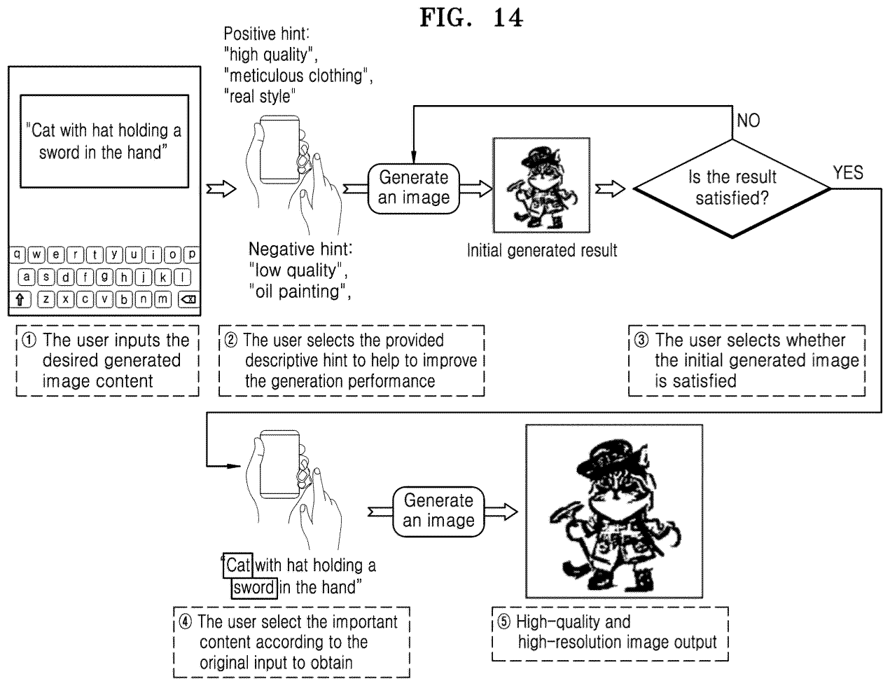

Based on at least one of the above embodiments, FIG. 14 shows an application scenario of the scheme according to an embodiment, wherein an image may be generated by using text. Specifically, the following operations may be included.

In operation 14.1 (represented by number \textcircled{1} in FIG. 14, similar in other operations, not repeated), the target content text input by the user is acquired, for example, “Cat with hat holding a sword in the hand”.

In operation 14.2, the corresponding recommended content constraint is determined based on the target content text, including positive descriptive text such as “high quality”, “meticulous clothing” or “real style” and negative descriptive text such as “low quality”, “oil painting” or “fuzzy”. The recommended content constraint is displayed to the user, the user selects the provided content constraint, and the device acquires the content constraint selected from the displayed recommended content constraint by the user. The content constraint is helpful for the improvement of the image generation performance.

In operation 14.3, an image is generated based on the content constraint selected by the user and the target content text, the user is inquired whether the user is satisfied with the generated result, and the next operation will be executed after the user is satisfied with the generated low-resolution image.

In operation 14.4, the user may select, according to the original input text, words for which the user wants to generate more details, for example, the word “Cat” and “sword” in the text “Cat with hat holding a sword in the hand”.

In operation 14.5, super-resolution processing is performed on the image based on the important words selected by the user to output the generated high-quality and high-resolution image.

In FIG. 14, operations 14.1 to 14.5 may be represented by numbers 1-5, respectively, circumscribed by a circle.

Thus, based on the user's text input, the high-quality and high-resolution image may be generated rapidly.

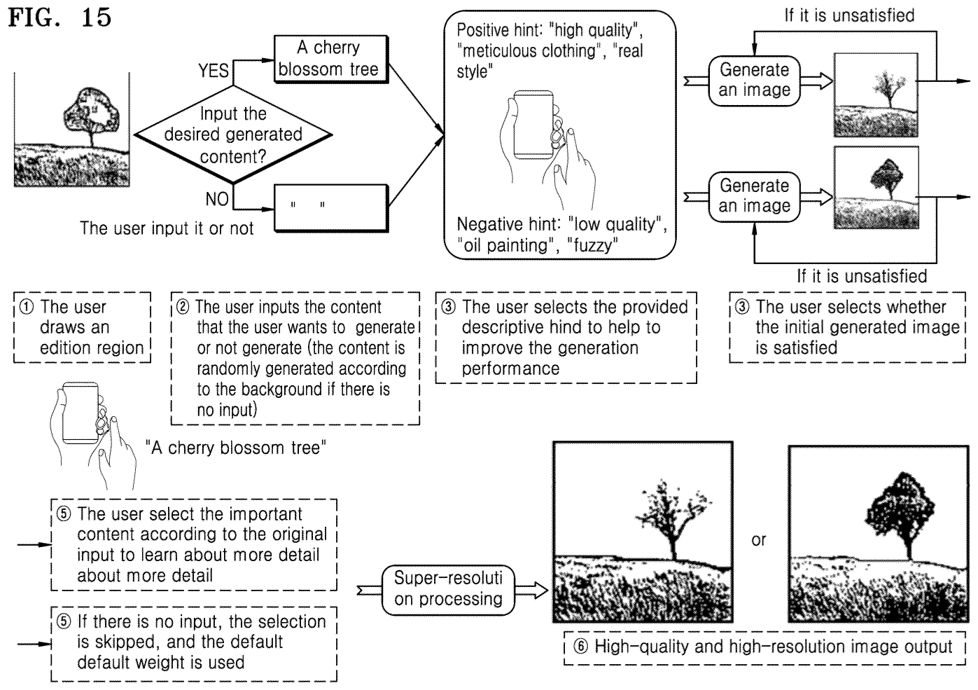

Based on at least one of the above embodiments, FIG. 15 shows another application scenario of the scheme according to an embodiment, wherein the image and text may be used to generate a new image, and it may be applied in image edition, image expansion, image restoration or other scenarios. Specifically, the following operations may be included.

In operation 15.1 (represented by number CD in FIG. 15, similar in other operations, not repeated), the original image of the user and the target edition region drawn on the original image by the user are acquired, and a mask of the target edition region is acquired.

In operation 15.2, the user is inquired whether there is a desired generated content; if there is a desired generated content, the text content (e.g., “cherry tree”) input by the user is acquired; if the user selects that there is an undesired generated content, the text content that the user does not want to generate input by the user is acquired; if the user selects that there is no desired generated content (For example, the user does not input anything), the blank text is acquired, and an image may be randomly generated according to the background. For example, in this operation, it is determined whether the user inputs a text content. If the user inputs a text content, the text content is acquired.

In operation 15.3, based on the target content text (if the user inputs text, the target content text may be determined according to the text content; if the user does not input text, the target content text may be determined according to the image content), the corresponding recommended content constraint is determined, including positive descriptive text such as “high quality”, “meticulous clothing” or “real style” and negative descriptive text such as “low quality”, “oil painting” or “fuzzy”. The recommended content constraint is displayed to the user, the user selects the provided content constraint, and the content constraint selected from the displayed recommended content constraint by the user is acquired. The content constraint is helpful for the improvement of the image generation performance.

In operation 15.4, a new image is generated based on the content constraint selected by the user and the image and text content input by the user, the user is inquired whether the user is satisfied with the generated result, and the next operation will be executed after the user is satisfied with the generated low-resolution image.

In operation 15.5, the user may select, according to the original input text, words for which the user wants to generate more details. For example, the word “cherry tree” is selected from the text “A cherry tree”. If the user does not input text, this selection operation may be skipped, and the default aggregation weight will be used in the subsequent super-resolution processing process.

In operation 15.6, super-resolution processing is performed on the image based on the important words selected by the user or the default aggregation weight to output the generated high-quality and high-resolution image accordingly.

In FIG. 15, operations 15.1 to 15.6 may be represented by numbers 1-6, respectively, circumscribed by a circle.

It is found through a large number of experiments that the technical scheme provided in the embodiment may better generate more natural detail information and have higher resolution and quality result than related models.

Secondly, the model size and time are as follows in comparison to the existing model:

| Model | Model size | | Operation time |
|---|---|---|---|
| Existing model that | 3.3 | GB | 128 s/image |
| does not share the | | | |
| attention weight | | | |
| Model in this scheme | 292 | MB | 2.8 s/image |
| | | | (20 operations, 512 size) |

As may be seen, compared with the model that does not share the attention weight, the model provided in the embodiment of the present application is greatly reduced in model size and inference time and meets the user's requirements for high-quality image generation.

In addition, after the correction module is added, the model provided in the embodiment can correct the texture that is not aligned in row and column in the image subjected to super-resolution processing. For example, the horizontal lines may be generated straighter. Thus, the visual effect is greatly improved.

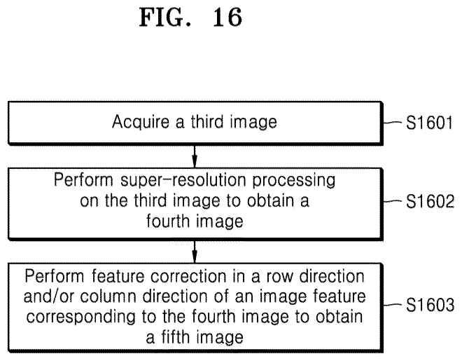

An embodiment further provides a method executed by an electronic device. As shown in FIG. 16, the method includes the following operations.

In operation S1601, a third image is acquired.

The third image may be an image acquired by the user in any way, for example, being photographed in real time, being downloaded, or being read locally, etc.; In an example, the third image may also be an image output by the model in the process of editing the image by the user, for example, a new image generated according to the text and/or image input by the user, etc. It will not be limited in the embodiment.

In operation S1602, super-resolution processing is performed on the third image to obtain a fourth image.

According to an embodiment, super-resolution processing may be performed on the third image with a lower resolution to convert it into an image with a higher resolution, so that the generated fourth image has a higher resolution while maintaining the original details of the third image. Super-resolution processing method may be selected to be used in this operation according to the type of images a user needs generated by those skilled in the art. For example, it is possible to use the super-resolution processing method provided in at least one of the above embodiments or use other super-resolution processing methods.

In operation S1603, feature correction is performed in a row direction and/or column direction of an image feature corresponding to the fourth image to obtain a fifth image.

Since human eyes are particularly sensitive to the alignment of regular features in the row direction and column direction, in order to avoid the situation where the poor detail texture in the generated low-resolution image (i.e., the third image) will be enlarged in the super-resolution processing process, it is difficult for the user to accept the misalignment that is not obvious itself. According to an embodiment, the misaligned texture features may be automatically corrected by calculating the relationship between features in the row direction (horizontal direction) and/or column direction (vertical direction), so that the visual effect of the high-resolution image may be improved.

In an embodiment, feature correction may be performed in the row direction and/or column direction of the image feature corresponding to the fourth image by using dilated convolution.

Compared with that the ordinary convolution can only use a small receptive field to obtain the relationship between adjacent square regions, According to an embodiment, the strong correlation correction of features in the row direction and/or the strong correlation correction of features in the column direction may be realized by using dilated convolution with a large receptive field in the row direction and/or column direction respectively, thereby achieving the effect of correcting misaligned texture generated by the super-resolution processing to repair the misalignment in the human eye sensitive structure.

In an embodiment, feature correction may be performed in the row direction and/or column direction of the image feature corresponding to the fourth image by cascaded dilated convolutions with at least two dilation indexes.

In an example, the dilated convolutions of at least two dilation indexes may be connected in series.

In an example, the number of dilated convolutions connected in series may be adjusted according to the feature dimension.

In an example, the dilation index corresponding to each dilated convolution may be adjusted according to the type of images a user needs generated.

In an example, the dilation indexes of the dilated convolutions connected in series may increase progressively.

In an example, performing, by using dilated convolution, feature correction in the row direction and/or column direction of the image feature corresponding to the fourth image may specifically include the following operations.

In operation S16031, an eleventh image feature and a twelfth image feature are determined based on the image feature corresponding to the fourth image.

According to an embodiment, feature correction in the row direction and the column direction may be realized by processing the image feature corresponding to the fourth image into two parts. In practical applications, an appropriate mode to process the image feature corresponding to the fourth image feature into two parts according to the type of images a user needs generated may be selected by those skilled in the art, and the embodiments of the present disclosure are not limited to these examples.

As an example, the image feature corresponding to the fourth image may be split into two parts. For example, the image feature corresponding to the fourth image is divided into two parts in the channel dimension. Thus, an eleventh image feature and a twelfth image feature may be obtained, and the calculation amount is reduced without basically affecting the calculation result. In an example, the image feature corresponding to the fourth image may be copied to obtain an eleventh image feature and a twelfth image feature (the two image features are the same), so that the calculation data is more complete.

In operation S16032, the eleventh image feature is compressed in the row direction, and dilated convolution is performed on the compressed eleventh image feature in the column direction for at least one time to obtain the corrected image feature in the column direction.

In an example, the eleventh image feature is globally pooled in the row direction to compress the eleventh image feature, so as to obtain the compressed eleventh image having a dimension of column*channel number.

Further, dilated convolution may be then performed on the compressed eleventh image feature for at least one time in the column direction. For example, feature extraction may be performed by multiple dilated convolutions with different dilation indexes connected in series. Thus, the perception of the global range in the column direction may be realized, and the corrected image feature in the column direction may be obtained.

The eleventh image feature after the dilated convolution in the column direction may be copied in the row dimension, and the expansion dimension is the same as that of the original eleventh image feature. Further, matrix multiplication is performed on the eleventh image feature with the expanded dimension and the original eleventh image feature to obtain the corrected image feature in the column direction.

In operation S16033, the twelfth image feature may be compressed in the column direction, and dilated convolution may be performed on the compressed twelfth image feature in the row direction for at least one time to obtain the corrected image feature in the row direction.

In an example, the twelfth image feature may be globally pooled in the row direction to compress the twelfth image feature, so as to obtain the compressed twelfth image feature having a dimension of row*channel number.

Further, dilated convolution may be then performed on the compressed twelfth image feature for at least one time in the row direction. For example, feature extraction may be performed by multiple dilated convolutions with different dilation indexes connected in series. Thus, the perception of the global range in the row direction may be realized, and the corrected image feature in the row direction is obtained.

The twelfth image feature after the dilated convolution in the row direction may be copied in the column dimension, and the expansion dimension is the same as that of the original twelfth image feature. Further, matrix multiplication is performed on the twelfth image feature with the expanded dimension and the original twelfth image feature to obtain the corrected image feature in the row direction.

In operation S16034, the corrected image features are fused.

The way of fusing the corrected and aligned image features corresponds to the way of processing the image feature corresponding to the fourth image into two parts.

As an example, if the eleventh image feature and the twelfth image feature are obtained by dividing the image feature corresponding to the fourth image into two parts in the channel dimension, the corrected and aligned image features may be spliced in the channel dimension. In one or more examples, if the eleventh image feature and the twelfth image feature are obtained by copying the image feature corresponding to the fourth image, the corrected and aligned image features may be subjected to summation, averaging, weighted summation or other operations. Those skilled in the art can select an appropriate fusion mode according to the type of images a user needs generated, and the embodiments of the present disclosure are not limited to these examples.

In other embodiments, the row alignment correction and the column alignment correction may also be executed in series. For example, it is possible to correct the row texture feature first and then correct the column texture feature of the row alignment result; In one or more examples, it is possible to correct the column texture feature first and then correct the row texture feature of the column alignment result. Those skilled in the art can expand according to the type of images a user needs generated, and the embodiments of the present disclosure are not limited to these examples.

According to one or more embodiments, based on the large receptive field module of columns and rows, by performing correction in the row direction and column direction on the images after the super-resolution processing by using any super-resolution method and by the interaction in the feature level, the misalignment in the row and column directions is automatically corrected, and the texture misaligned in row and column is automatically corrected. For example, the horizontal lines may be generated straighter, so that the super-resolution effect of the regular texture is improved. Thus, on the premise that human eyes are most sensitive to the regular texture, the visual perception is enhanced, and the user experience is improved accordingly.

The technical solutions provided in the embodiments of the present application may be applied to various electronic devices, including but not limited to, mobile terminals, intelligent terminals, etc., for example, smart phones, flat computers, notebook computers, intelligent wearable devices (e.g., watches, glasses, etc.), smart speakers, vehicle-mounted terminals, personal digital assistants, portable multimedia players, navigation apparatuses, but not limited thereto. It should be understood by those skilled in the art that, except for the elements special for mobile purpose, the configurations according to the embodiments of the present application can also be applied to a fixed type of terminals, such as digital TV sets or desktop computers.

The technical solutions provided in the embodiments of the present application can also be applied to image generation and super-resolution processing in servers, such as separate physical servers, which may be server clusters or distributed systems composed of multiple physical servers, or may be cloud servers that provide basic cloud computing services such as cloud services, cloud databases, cloud computing, cloud functions, cloud storage, network services, cloud communication, middleware services, domain name services, security services, content delivery networks (CDNs) and big data and artificial intelligent platforms.

Specifically, the technical solutions provided in the embodiments of the present application may be applied to the image AI edition applications on various electronic devices to improve the speed and performance of high-resolution image generation, so that the fascinating image generation result may be generated, the user can release imagination, and more beautiful images may be obtained from the input text, image and the like.

An embodiment of the present disclosure further comprise an electronic device comprising a processor and, In an example, a transceiver and/or memory coupled to the processor configured to perform the operations of the method provided in any of the optional embodiments of the present disclosure.

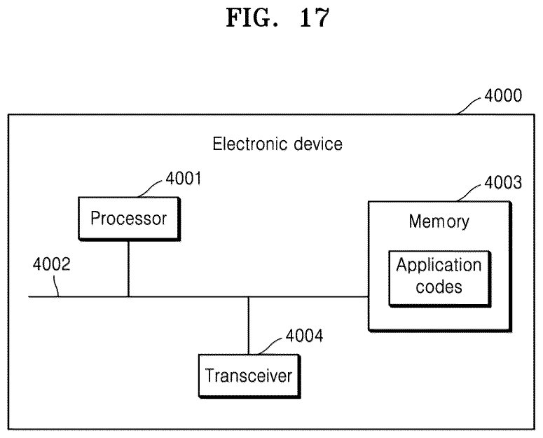

FIG. 17 shows a schematic structure diagram of an electronic device to which an embodiment of the present embodiments is applied. As shown in FIG. 17, the electronic device 4000 shown in FIG. 17 may include a processor 4001 and a memory 4003. The processor 4001 is connected to the memory 4003, for example, through a bus 4002. In an example, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 does not constitute a limitation to the embodiments of the present disclosure. In an example, the electronic device may be a first network node, a second network node or a third network node.

The processor 4001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination thereof. It may implement or execute the various exemplary logical blocks, modules and circuits described in connection with this disclosure. The processor 4001 may also be a combination that implements computing functions, such as a combination of one or more microprocessors, a combination of a DSP and a microprocessor, and the like.

The bus 4002 may include a path to transfer information between the components described above. The bus 4002 may be a PCI (Peripheral Component Interconnect) bus or an EISA (Extended Industry Standard Architecture) bus or the like. The bus 4002 may be divided into an address bus, a data bus, a control bus, and the like. For ease of representation, only one thick line is shown in FIG. 17, but it does not mean that there is only one bus or one type of bus.

The memory 4003 may be a ROM (Read Only Memory) or other types of static storage devices that can store static information and instructions, a RAM (Random Access Memory) or other types of dynamic storage devices that can store information and instructions, and can also be EEPROM (Electrically Erasable Programmable Read Only Memory), CD-ROM (Compact Disc Read Only Memory) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 4003 is used for storing computer programs for executing the embodiments of the present disclosure, and the execution is controlled by the processor 4001. The processor 2401 is configured to execute the computer programs stored in the memory 4003 to implement the operations shown in the foregoing method embodiments.

Embodiments of the present disclosure provide a computer-readable storage medium having a computer program stored on the computer-readable storage medium, the computer program, when executed by a processor, implements the operations and corresponding contents of the foregoing method embodiments.

Embodiments of the present disclosure also provide a computer program product including a computer program, the computer program when executed by a processor realizing the operations and corresponding contents of the preceding method embodiments.

The terms “first”, “second”, “third”, “fourth”, “1”, “2”, etc. (if present) in the specification and claims of this disclosure and the accompanying drawings above are used to distinguish similar objects and need not be used to describe a particular order or sequence. It should be understood that the data so used is interchangeable where appropriate so that embodiments of the present disclosure described herein may be implemented in an order other than that illustrated or described in the text.

It should be understood that while the flow diagrams of embodiments of the present disclosure indicate the individual operational operations by arrows, the order in which these operations are performed is not limited to the order indicated by the arrows. Unless explicitly stated herein, in some implementation scenarios of embodiments of the present disclosure, the implementation operations in the respective flowcharts may be performed in other orders as desired. In addition, some, or all of the operations in each flowchart may include multiple sub-operations or multiple phases based on the actual implementation scenario. Some or all of these sub-operations or stages may be executed at the same moment, and each of these sub-operations or stages can also be executed at different moments separately. The order of execution of these sub-operations or stages may be flexibly configured according to requirements in different scenarios of execution time, and the embodiments of the present disclosure are not limited thereto.

According to an aspect of the disclosure, a method executed by an electronic device, may include, performing, using a first artificial intelligence (AI) network, image processing based on input information to obtain a first image and image guidance information, the image guidance information including at least one of spatial correlation guidance information and semantic correlation guidance information. The method may include performing, using a second AI network, resolution processing on the first image based on the image guidance information to obtain a second image.

The spatial correlation guidance information may include a spatial correlation weight between different spatial positions of the first image. The semantic correlation guidance information may include at least one of a semantic correlation weight between the different spatial positions of the first image and text content constraints.

The first AI network may include at least one first spatial attention module. The spatial correlation guidance information may include information of at least one stage in the first spatial attention module. The semantic correlation guidance information may include information corresponding to at least one token.

The second AI network may include at least one second spatial attention module and at least one second semantic attention module. The method may include performing the resolution processing on the first image based on the image guidance information by using a second AI network. The performing the resolution processing on the first image based on the image guidance information by using a second AI network may include performing, using the at least one second spatial attention module spatial attention processing on an input first image feature based on the spatial correlation guidance information. The performing the resolution processing on the first image based on the image guidance information by using a second AI network may include performing, using the at least one second semantic attention module, semantic attention processing on an input second image feature based on the semantic correlation guidance information.

The obtaining, using the second AI network, performing the resolution processing on the first image based on the image guidance information, a second image may include performing, using the at least one second spatial attention module spatial attention processing on a first image feature based on the spatial correlation guidance information.

The obtaining, using the second AI network, performing the resolution processing on the first image based on the image guidance information, a second image may include, performing, using the at least one second semantic attention module, semantic attention processing on a second image feature based on the semantic correlation guidance information.

The first AI network may include at least one first semantic attention module. The semantic correlation guidance information may include information corresponding to at least one token in the at least one first semantic attention module. The performing the semantic attention processing may include, for each token, fusing the semantic correlation guidance information corresponding to a respective token in the at least one first semantic attention module to obtain semantic correlation guidance information corresponding to respective token. The performing the semantic attention processing may include performing, using the at least one second semantic attention module, the semantic attention processing on the input second image feature based on the semantic correlation guidance information corresponding to the respective token.

The performing the semantic attention processing may include, obtaining, for each token, fusing the semantic correlation guidance information corresponding to a respective token in the at least one first semantic attention module, semantic correlation guidance information corresponding to the respective token.

The fusing the semantic correlation guidance information corresponding to the respective token in the at least one first semantic attention module may include, for each execution of the first AI network, transforming the semantic correlation guidance information corresponding to the token in the at least one first semantic attention module to a same size as the first image, The fusing the semantic correlation guidance information corresponding to the respective token in the at least one first semantic attention module may include, for each execution of the first AI network, superimposing the transformed semantic correlation guidance information on a result of a prior execution of the first AI network to obtain accumulated first semantic correlation guidance information. The fusing the semantic correlation guidance information corresponding to the respective token in the at least one first semantic attention module may include, superimposing the accumulated first semantic correlation guidance information obtained by each execution of the first AI network to obtain accumulated second semantic correlation guidance information. The fusing the semantic correlation guidance information corresponding to the respective token in the at least one first semantic attention module may include normalizing the accumulated second semantic correlation guidance information and the accumulated first semantic correlation guidance information.

The obtaining semantic correlation guidance information corresponding to the respective token may include, obtaining, for each execution of the first AI network, transforming the semantic correlation guidance information corresponding to the token in the at least one first semantic attention module to a same size as the first image, and superimposing the transformed semantic correlation guidance information on a result of a prior execution of the first AI network, accumulated first semantic correlation guidance information. The obtaining semantic correlation guidance information corresponding to the respective token may include, obtaining, superimposing the accumulated first semantic correlation guidance information obtained by the each execution of the first AI network, accumulated second semantic correlation guidance information. The obtaining semantic correlation guidance information corresponding to the respective token may include, normalizing the accumulated second semantic correlation guidance information and the accumulated first semantic correlation guidance information.

The second AI network may include at least one second spatial attention module and at least one second semantic attention module. The performing the resolution processing on the first image may include performing, based on the spatial correlation guidance information that includes information of at least one stage in the first spatial attention module, spatial attention processing on a first image feature corresponding to the at least one second spatial attention module. The performing the resolution processing on the first image may include fusing the semantic correlation guidance information corresponding to the at least one token. The performing the resolution processing on the first image may include performing, based on the fused semantic correlation guidance information, semantic attention processing on a second image feature corresponding to the at least one second semantic attention module.

The obtaining, using the second AI network, performing the resolution processing on the first image based on the guidance information, a second image may include performing, based on the spatial correlation guidance information that comprises information of at least one stage in the first spatial attention module, spatial attention processing on the first image feature corresponding to the at least one second spatial attention module. The obtaining, using the second AI network, performing the resolution processing on the first image based on the guidance information, a second image may include fusing the semantic correlation guidance information corresponding to the at least one token. The obtaining, using the second AI network, performing the resolution processing on the first image based on the guidance information, a second image may include performing, based on the fused semantic correlation guidance information, semantic attention processing on the second image feature corresponding to the at least one second semantic attention module.

For each spatial correlation guidance information in the first spatial attention module, the performing the spatial attention processing on the first image feature corresponding to the at least one second spatial attention module may include obtaining a fourth image feature and a fifth image feature based on the first image feature corresponding to the at least one second spatial attention module. For each spatial correlation guidance information in the first spatial attention module, the performing the spatial attention processing on the first image feature corresponding to the at least one second spatial attention module may include performing, based on the spatial correlation guidance information, spatial attention processing on the fourth image feature to obtain a sixth image feature. For each spatial correlation guidance information in the first spatial attention module, the performing the spatial attention processing on the first image feature corresponding to the at least one second spatial attention module may include performing channel attention adjustment on the fifth image feature to obtain a seventh image feature. For each spatial correlation guidance information in the first spatial attention module, the performing the spatial attention processing on the first image feature corresponding to the at least one second spatial attention module may include fusing the sixth image feature with the seventh image feature.

The performing the spatial attention processing on the first image feature corresponding to the at least one second spatial attention module may include obtaining a fourth image feature and a fifth image feature based on the first image feature corresponding to the at least one second spatial attention module. The performing the spatial attention processing on the first image feature corresponding to the at least one second spatial attention module may include obtaining a sixth image feature, performing, based on the spatial correlation guidance information, the spatial attention processing on the fourth image feature. The performing the spatial attention processing on the first image feature corresponding to the at least one second spatial attention module may include obtaining a seventh image feature, performing channel attention adjustment on the fifth image feature. The performing the spatial attention processing on the first image feature corresponding to the at least one second spatial attention module may include fusing the sixth image feature with the seventh image feature.

The performing the channel attention adjustment on the fifth image feature may include compressing the fifth image feature in a spatial dimension to obtain an eighth image feature. The performing the channel attention adjustment on the fifth image feature may include obtaining a channel attention weight of the fifth image feature based on the eighth image feature. The performing the channel attention adjustment on the fifth image feature may include performing the channel attention adjustment on the fifth image feature based on the channel attention weight.

The obtaining the seventh image feature, performing the channel attention adjustment on the fifth image feature may include obtaining an eighth image feature, compressing the fifth image feature in a spatial dimension. The obtaining the seventh image feature, performing the channel attention adjustment on the fifth image feature may include obtaining a channel attention weight of the fifth image feature based on the eighth image feature. The obtaining the seventh image feature, performing the channel attention adjustment on the fifth image feature may include performing the channel attention adjustment on the fifth image feature based on the channel attention weight.

The fusing the semantic correlation guidance information corresponding to the at least one token may include acquiring a weight corresponding to the at least one token. The fusing the semantic correlation guidance information corresponding to at least one token may include performing, based on the weight corresponding to the at least one token, weighted fusion on the semantic correlation guidance information corresponding to the at least one token.

The acquiring the weight corresponding to the at least one token may include displaying the at least one token. The acquiring the weight corresponding to the at least one token may include determining the weight corresponding to the at least one token in response to a user's first selection operation on a target token in the at least one token.

The performing the semantic attention processing on the second image feature corresponding to the at least one second semantic attention module may include fusing the fused semantic correlation guidance information with a third image feature of at least one scale corresponding to the first image to obtain a global semantic feature of the at least one scale. The performing the semantic attention processing on the second image feature corresponding to the at least one second semantic attention module may include performing, based on the global semantic feature of the at least one scale, semantic attention processing on the second image feature corresponding to the at least one second semantic attention module.

The performing, the semantic attention processing on the second image feature corresponding to the at least one second semantic attention module may include, obtaining, fusing the fused semantic correlation guidance information with a third image feature of at least one scale corresponding to the first image, a global semantic feature of the at least one scale. The performing, the semantic attention processing on the second image feature corresponding to the at least one second semantic attention module may include, performing, based on the global semantic feature of the at least one scale, semantic attention processing on the second image feature corresponding to the at least one second semantic attention module.

The second AI network may include a correction module. The method may include, performing, by using the correction module, feature correction in at least one of a row direction and a column direction of an image feature corresponding to the first image.

The performing feature correction in the at least one of the row direction and the column direction of an image feature corresponding to the first image may include performing, using dilated convolution, the feature correction in the row direction and/or the column direction of the image feature corresponding to the first image.

The performing, using dilated convolution, the feature correction in the at least one of the row direction and column direction of the image feature corresponding to the first image may include determining a ninth image feature and a tenth image feature based on the image feature corresponding to the first image. The performing, using dilated convolution, the feature correction in the at least one of the row direction and column direction of the image feature corresponding to the first image may include compressing the ninth image feature in the row direction, and performing the dilated convolution on the compressed ninth image feature in the column direction for at least one iteration to obtain the corrected image feature in the column direction. The performing, using dilated convolution, the feature correction in the at least one of the row direction and column direction of the image feature corresponding to the first image may include compressing the tenth image feature in the column direction, and performing dilated convolution on the compressed tenth image feature in the row direction for at least one iteration to obtain the corrected image feature in the row direction; and fusing the corrected image feature in the column direction with the corrected image feature in the row direction.

The performing, using dilated convolution, the feature correction in the at least one of the row direction and column direction of the image feature corresponding to the first image may include obtaining, compressing the ninth image feature in the row direction and performing the dilated convolution on the compressed ninth image feature in the column direction for at least one iteration, the corrected image feature in the column direction.

The image processing may include image inpainting. The image processing may include image outpainting. The image processing may include text-based image generation. The image processing may include image fusion. The image processing may include image style transformation.

According to an aspect of the disclosure, a method executed by an electronic device may include acquiring a third image. The method may include performing resolution processing on the third image to obtain a fourth image. The method may include performing feature correction in a row direction and/or column direction of an image feature corresponding to the fourth image to obtain a fifth image.

According to an aspect of the disclosure, a non-transitory computer-readable storage medium has instructions stored therein, which when executed by a process, cause the processor to execute a method including performing, using a first artificial intelligence (AI) network, image processing based on input information to obtain a first image and image guidance information, the image guidance information comprising at least one of spatial correlation guidance information and semantic correlation guidance information. The non-transitory computer-readable storage medium has instructions stored therein, which when executed by a process, cause the processor to execute a method including performing, using a second AI network, resolution processing on the first image based on the image guidance information to obtain a second image.

According to an aspect of the disclosure, the spatial correlation guidance information may include a spatial correlation weight between different spatial positions of the first image; and the semantic correlation guidance information comprises at least one of a semantic correlation weight between different spatial positions of the first image and text content constraints.

The above text and accompanying drawings are provided as examples only to assist the reader in understanding the present disclosure. They are not intended and should not be construed as limiting the scope of the present disclosure in any way. Although certain embodiments and examples have been provided, based on what is disclosed herein, it will be apparent to those skilled in the art that the embodiments and examples shown may be altered without departing from the scope of the present disclosure. Employing other similar means of implementation based on the technical ideas of the present disclosure also fall within the scope of protection of embodiments of the present disclosure.

1. A method executed by an electronic device, the method comprising:
obtaining, using a first artificial intelligence (AI) network, a first image and image guidance information by performing image processing, wherein the image guidance information comprises at least one of spatial correlation guidance information and semantic correlation guidance information; and
obtaining, using a second AI network, a second image by performing resolution processing on the first image based on the image guidance information.

2. The method according to claim 1, wherein the spatial correlation guidance information comprises a spatial correlation weight between different spatial positions of the first image, and
wherein the semantic correlation guidance information comprises at least one of a semantic correlation weight between the different spatial positions of the first image and text content constraints.

3. The method according to claim 1, wherein the first AI network comprises at least one first spatial attention module,
wherein the spatial correlation guidance information comprises information of at least one stage in the first spatial attention module, and
wherein the semantic correlation guidance information corresponds to at least one token.

4. The method according to claim 1, wherein the second AI network comprises at least one second spatial attention module and at least one second semantic attention module, and
wherein the obtaining, using the second AI network, a second image, by performing the resolution processing on the first image based on the image guidance information comprises at least one of:
performing, using the at least one second spatial attention module, spatial attention processing on a first image feature based on the spatial correlation guidance information; and
performing, using the at least one second semantic attention module, semantic attention processing on a second image feature based on the semantic correlation guidance information.

5. The method according to claim 4, wherein the first AI network comprises at least one first semantic attention module,
wherein the semantic correlation guidance information comprises information corresponding to at least one token in the at least one first semantic attention module, and
wherein the performing the semantic attention processing comprises:
obtaining, for each token, semantic correlation guidance information corresponding to the respective token by fusing the semantic correlation guidance information corresponding to the respective token in the at least one first semantic attention module; and
performing, using the at least one second semantic attention module, the semantic attention processing on the input second image feature based on the semantic correlation guidance information corresponding to the respective token.

6. The method according to claim 5, wherein the obtaining, for each token, semantic correlation guidance information corresponding to the respective token by fusing the semantic correlation guidance information corresponding to the respective token in the at least one first semantic attention module comprises:
obtaining, for each execution of the first AI network, accumulated first semantic correlation guidance information by transforming the semantic correlation guidance information corresponding to the token in the at least one first semantic attention module to a same size as the first image, and superimposing the transformed semantic correlation guidance information on a result of a prior execution of the first AI network;
obtaining accumulated second semantic correlation guidance information by superimposing the accumulated first semantic correlation guidance information obtained by the each execution of the first AI network; and
normalizing the accumulated second semantic correlation guidance information and the accumulated first semantic correlation guidance information.

7. The method according to claim 1, wherein the second AI network comprises at least one second spatial attention module and at least one second semantic attention module, and
wherein the obtaining, using the second AI network, a second image by performing the resolution processing on the first image based on the guidance information comprises at least one of:
performing, based on the spatial correlation guidance information that comprises information of at least one stage in the first spatial attention module, spatial attention processing on the first image feature corresponding to the at least one second spatial attention module;
fusing the semantic correlation guidance information corresponding to the at least one token; and
performing, based on the fused semantic correlation guidance information, semantic attention processing on the second image feature corresponding to the at least one second semantic attention module.

8. The method according to claim 7, wherein, the performing the spatial attention processing on the first image feature corresponding to the at least one second spatial attention module comprises:
obtaining a fourth image feature and a fifth image feature based on the first image feature corresponding to the at least one second spatial attention module;
obtaining a sixth image feature, based on the spatial correlation guidance information, by performing the spatial attention processing on the fourth image feature;
obtaining a seventh image feature by performing channel attention adjustment on the fifth image feature; and
fusing the sixth image feature with the seventh image feature.

9. The method according to claim 8, wherein the obtaining the seventh image feature by performing the channel attention adjustment on the fifth image feature comprises:
obtaining an eighth image feature, compressing the fifth image feature in a spatial dimension;
obtaining a channel attention weight of the fifth image feature based on the eighth image feature; and
performing the channel attention adjustment on the fifth image feature based on the channel attention weight.

10. The method according to claim 7, wherein the fusing the semantic correlation guidance information corresponding to the at least one token comprises:
acquiring a weight corresponding to the at least one token; and
performing, based on the weight corresponding to the at least one token, weighted fusion on the semantic correlation guidance information corresponding to the at least one token.

11. The method according to claim 10, wherein the acquiring the weight corresponding to the at least one token comprises:
displaying the at least one token; and
determining the weight corresponding to the at least one token in response to a user's first selection operation on a target token in the at least one token.

12. The method according to claim 7, wherein the performing the semantic attention processing on the second image feature corresponding to the at least one second semantic attention module comprises:
obtaining, a global semantic feature of the at least one scale by fusing the fused semantic correlation guidance information with a third image feature of at least one scale corresponding to the first image; and
performing, based on the global semantic feature of the at least one scale, semantic attention processing on the second image feature corresponding to the at least one second semantic attention module.

13. The method according to claim 1, wherein the second AI network further comprises a correction module, and the method further comprises:
performing, by using the correction module, feature correction in at least one of a row direction and a column direction of an image feature corresponding to the first image.

14. The method according to claim 13, wherein the performing the feature correction in the at least one of the row direction and the column direction of the image feature corresponding to the first image comprises:
performing, using dilated convolution, the feature correction in the at least one of the row direction and the column direction of the image feature corresponding to the first image.

15. The method according to claim 14, wherein the performing, using dilated convolution, the feature correction in the at least one of the row direction and the column direction of the image feature corresponding to the first image comprises:
determining a ninth image feature and a tenth image feature based on the image feature corresponding to the first image;
obtaining the corrected image feature in the column direction by compressing the ninth image feature in the row direction and performing the dilated convolution on the compressed ninth image feature in the column direction for at least one iteration;
compressing the tenth image feature in the column direction, and performing the dilated convolution on the compressed tenth image feature in the row direction for at least one iteration to obtain the corrected image feature in the row direction; and
fusing the corrected image feature in the column direction with the corrected image feature in the row direction.

16. The method according to claim 15, wherein the image processing comprises at least one of:
image inpainting, image outpainting, text-based image generation, image fusion, and image style transformation.

17. The method according to claim 1, the method comprising:
acquiring a third image;
performing resolution processing on the third image to obtain a fourth image; and
performing feature correction in a row direction and/or column direction of an image feature corresponding to the fourth image to obtain a fifth image.

18. An electronic device, comprising:
a memory storing instructions; and
at least one processor configured to execute the instructions to:
obtain, using a first artificial intelligence (AI) network, a first image and image guidance information by performing image processing based on input information,
wherein the image guidance information comprising at least one of spatial correlation guidance information and semantic correlation guidance information; and
obtain, using a second AI network, a second image by performing resolution processing on the first image based on the image guidance information.

19. A non-transitory computer-readable storage medium having instructions stored therein, which when executed by a processor cause the processor to execute a method comprising:
obtaining, using a first artificial intelligence (AI) network, based on input information, a first image and image guidance information by performing image processing;
wherein the image guidance information comprises at least one of spatial correlation guidance information and semantic correlation guidance information; and
obtaining, using a second AI network, a second image by performing resolution processing on the first image based on the image guidance information.

20. The non-transitory computer-readable storage medium according to claim 19, wherein the spatial correlation guidance information comprises a spatial correlation weight between different spatial positions of the first image; and
wherein the semantic correlation guidance information comprises at least one of a semantic correlation weight between different spatial positions of the first image and text content constraints.
